(19) United States
(12) Patent Application Publication
(10) Pub. No.: US 2005/0139776 A1
(43) Pub. Date: Jun. 30, 2005

(54) Photon violation spectroscopy

(76) Inventor: Eric Stanley Reiter, Pacifica, CA (US)

Correspondence Address: Eric Reiter, 251 Nelson Avenue, Pacifica, CA, 94044, US

(21) Appl. No.: 10/984,456

(22) Filed: Nov. 8, 2004

Related U.S. Application Data
(60) Provisional application No. 60/533,064, filed on Dec. 29, 2003.

(51) Int. Cl. G01T 1/00

(52) U.S. Cl. 250/393; 250/394

(57) ABSTRACT

The method typically uses spontaneous gamma rays from radioisotopes, either cadmium-109 at 88 keV or cobalt-57 at 122 keV, detected with NaI(Tl) or HPGe. After a two-part split, detection pulses are windowed for the characteristic gamma ray pulse amplitude and measured in coincidence. By using high resolution detectors and gamma rays that match the part of the spectrum where the detector has a high photoelectric effect efficiency, coincidence rates are found to substantially exceed the chance rate. This refutes the quantum mechanical prediction of energy quantization. This unquantum effect implies that photons are an illusion, and is explained by an extension of the abandoned loading theory of Planck to derive the photoelectric effect equation. In scattering gamma rays in a beam splitter geometry, changes in response to magnetic fields, temperature, and crystal orientation are tools for measuring properties of atomic bonds. With detectors in a tandem geometry where the first detector is both scatterer and absorber, tests reveal properties consistent with a classical gamma ray model. The method has also shown use in discovering that different crystalline states of the gamma ray source change the extent coincidence rates exceed chance, whereas conventional gamma ray spectroscopy shows no substantial dependence upon these applied variables.

### CROSS-REFERENCE TO RELATED APPLICATIONS

This application claims priority from a provisional U.S. patent application, appl. No. 60/533,064, filed on date Dec. 29, 2003, under the name Eric S. Reiter, for title PHOTON VIOLATION SPECTROSCOPY, hereby incorporated by reference.

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

1. Technical Field

This invention relates to the field of physical measurement and more particularly to the field of gamma ray spectroscopy.

2. Prior Art

Prior art is in the form of physics experiments interpreted by scientists to conclude energy is always quantized. There is prior theory, previously rejected by the physical science community, in support of the possibility of my findings.

The following thought experiment is important in the history of physics. In N Bohr's book, Atomic Physics and Human Knowledge (1958) pg. 50, he describes his 1927 discussions with Einstein and describes Einstein's two-part beam splitter thought experiment:
“If a semi-reflecting mirror is placed in the way of a photon, leaving two possibilities for its direction of propagation, the photon would be recorded on one, and only one, of two photographic plates situated at great distances in the two directions in question, or else we may, by replacing the plates by mirrors, observe effects exhibiting an interference between the two reflected wave-trains.”
   This is the principle of the photon. I will also call it the beam splitter test. It is the first half of this quote that describes a particle property of light. The meaning of this thought experiment was clearly elaborated upon by Heisenberg in his book Quantum Theory (1930) pg. 39. Heisenberg concluded that the probability-amplitude wave undergoes an instantaneous “reduction of the wave packet” upon finding the photon in one part of the beam splitter to avoid finding the photon in the other part. DeBroglie also discusses a version of Einstein's thought experiment in terms of a generalized particle, not just photons, in An Introduction to the Study of Wave Mechanics (1930) pg. 142.

An early version of Einstein's beam splitter test was performed by M P Givens, “An experimental study of the quantum nature of x-rays,” Philos. Mag. 37 (1946) pgs. 335-346, whereby x-rays from a Coolidge tube were directed at a NaCl target. The x-rays were arranged to Bragg reflect and split into two beams toward Geiger-Mueller detectors. X-ray events detected in coincidence did not exceed the low rate expected by chance, consistent with the quantum mechanical prediction. They did not break chance.

In another beam splitter test, visible light was tested to see if detector pulses in coincidences could defy chance, performed by E Brannen and HIS Ferguson in “The question of correlation between photons in coherent light rays” Nature, 4531 (1956) pg. 481. They used a filtered mercury arc line as a source, a beam splitter, and two photomultiplier tubes (PMT) as detectors, and searched for coincidences from pulses from the PMTs. The coincidences detected did not break chance. These authors state “if such a correlation did exist it would call for a major revision of some fundamental concepts in quantum mechanics.” In other words, if anyone were to break chance in a single hv detection beam splitter test, it would break quantum mechanics.

An experimental beam splitter test designed to detect one hv released at a time was not published until 1974 by J F Clauser in, “Experimental distinction between the quantum and classical field theoretic predictions for the photoelectric effect,” Phys. Rev. D, 9 (1974) pgs. 853-860. Clauser used an elaborate scheme that delivered a gating pulse in a two-photon emission cascade, and used PMT detectors. His results were plots of the time difference between detections (Δt plots) in a featureless flat distribution, as expected by quantum mechanics and as expected by chance. Recent writing by Clauser in Coherence and Quantum Optics VIII, ed. Bigelow (2003) pgs. 19-43 “Early history of Bell's theorem” reviews his beam splitter test, showing he still maintains: “The experiment's results show that both quantum mechanics and quantum electrodynamics hold true, and photons do not split at a half silvered mirror.”

A similar experiment to that of Clauser's was performed P Grainger, G Roger, A Aspect, “A new light on single photon interferences,” Ann. N Y Acad. Sci. 480 (1986) pgs. 98-107, and I quote them: “ . . . quantum mechanics predicts a perfect anticorrelation for photodetections on both sides of the beam splitter, while any description involving classical fields would predict some amount of coincidences.”

A review article featuring the work of Grainger et al, by A L Robinson appeared in Science 231 (1986) pg. 671, “Demonstrating single photon interference.” In his opening statement I quote: “One of the hallmarks of quantum mechanics is the wave-particle duality of matter at the atomic level. Sixty years of theory and experiment provide no reason to doubt the proposition despite the strange consequences that can follow.” This was an article about an experiment with light, yet it clearly implied a wave-particle duality for matter.

There are patents, such as U.S. Pat. No. 06,188,768 issued to IBM on Feb. 13, 2001, that depend on the quantum mechanical interpretation of these prior art beam splitter experiments. I quote from this patent: “This is possible because single photons cannot be split into smaller pieces (intercepted or diverted photons simply won't arrive at the intended destination) . . . ” (parenthesis in original).

Obviously a great investment has been made by the industrial and scientific communities in the idea that light is photons, and that it is not possible to break chance in the beam splitter test. I have found no evidence in the scientific literature of any measurement that violates quantum mechanics or the principle of the photon in any manner remotely similar to the method I have developed and describe in this disclosure. To my knowledge, there is no prior art in any method of measurement based upon the failure of quantum mechanics. Quantum mechanics has never before been shown to fail for light in such a convincing manner as I will show. The only prior art in support of my method is theoretical.

A classical alternative to quantization, as applied to light, was called the loading theory. The earliest works I could find on the loading theory are from what is known as Planck's second theory. The history of Max Planck's second theory is described in T Kuhn's Black-Body theory and the Quantum Discontinuity 1894-1912 (1978) pg. 235. In Planck's “Eine neue Strahlungshypothese” of 1911, an article found in a collection of Planck's works Physikalische Abhandlungen und Vorträge (1958) volume 2, he introduces a quantity of energy ε that can have any value between 0 and hv, where h is Planck's constant and v is electromagnetic frequency. Planck uses this ε in his derivation of the black body distribution. Planck modeled that light absorbers could have any initial energy up to a threshold of energy hv. Later in his book The Theory of Heat Radiation, a Dover translation of his ‘Warmestrahlung of 1913, Planck clarifies his model by stating on pg. 153 “Now, since in the law of absorption just assumed the hypothesis of quanta has as yet found no room, it follows that it must come into play in some way or other in the emission of the oscillator, and this is provided for by the hypothesis of the emission of quanta.” Planck's quanta were only at the point of emission. Planck then explains “ . . . an oscillator will or will not emit at an instant when its energy has reached an integral multiple of ε.” This is Planck's threshold concept. Kuhn describes how Planck had later abandoned this theory of continuous absorption and explosive emission. The only other work I could find on the loading theory was by P Debye and A Sommerfeld in “Theorie des lichtelektrischen Effektes vom Standpunkt des Wirkungsquantums” Ann. d. Physik 41 (1913) pg. 78, where they calculate how an electron would be driven by a light field until the electron escaped. The loading theory was mentioned in Compton and Allison's book X-Rays in Theory and Experiment (1935) pg. 47, and Millikan's book Electrons (+ and −) (1937) pg. 253.

We were warned against light quanta by many greats in physics. I quote my translation of H A Lorentz from “Die Hypothese der Lichtquanten” Physik. Zeitschrift, 11 (1910) pg. 349: “Light quanta which move concentrated in a small space and always remain undivided are completely out of the question.”

### BACKGROUND OF THE INVENTION

### Introduction

This invention relates to transcending the following general assumption in physics: an absorption event that releases a quantity of energy is due to a particle of that same quantity of energy being incident upon the absorber immediately preceding the absorption event. A subtle shift in understanding physics in terms of thresholds instead of quanta is required. My theoretical work is an extension of Planck's loading theory where he introduced the threshold concept.

My method is based upon a new theoretical and experimental physics that I have developed. The practical application of this new physics is a new form of spectroscopy in physical measurement that reveals information never before available. In its essence my method is a way to show that we need to replace a quantum mechanical probability wave with a physical wave. I have successfully applied this method to the beam splitter test, which has been claimed to prove that the electromagnetic field is quantized, as described above in prior art. In all previous beam splitter tests, there has been no evidence contradicting the idea that a quantum of energy goes either one way or the other at a beam splitter. Using gamma rays in the beam splitter test, using certain radioisotope sources and high resolution detectors, and exhaustively eliminating sources of artifact, I found the rate of detecting coincidences will break chance. This implies that a single spontaneous decay emits a gamma ray that radiates classically and that an energy less than the originally emitted hv can gamma-trigger two detection events in coincidence. I call my violation of quantum mechanics the unquantum effect.

In a practical application the first step is to confirm that coincidence rates surpass a calculated chance rate. The second step is to measure the extent to which the ratio of the two rates exceeds unity and responds to modification of an applied condition. When the ratio exceeds unity, detection events in coincidence can generate a pulse to gate the capture of pulse amplitude data from one of the detectors. These coincidence-gated pulse amplitude plots can reveal Rayleigh/Compton scattering ratios to determine if the gamma ray interacts with a stiff or flexible charge-wave in a material under study. If the gamma ray can split to trigger two events, it can trigger higher numbers of events, and reading this multiplicity is another mode of measure. Several such modes have been tested. The variety of geometries, detectors, modes of detection, conditions imposed on the scatterer, and chemical states of the source makes for a very rich spectroscopy. This spectroscopy can serve to probe atomic bonds and study the nature of gamma rays as classical waves, and is useful in both fundamental investigations in physics and practical applications in material science.

### Theoretical Background

It is very important that I take the time and space to include the historical and theoretical components that have led to my discovery. Without this background it is easy to falsely assume that my findings do not make sense in the context of what has been taught in modern physics. To show that the physics behind this invention is reasonable I will derive equations for the Compton and photoelectric effects without resort to energy quantization, and I will reveal misleading ideas found in most physics textbooks.

Schrödinger first described a wave-oriented derivation of the Compton effect, and it is well described in Compton and Allison's book, X-Rays in Theory and Experiment (1935). The algebra is the same as my derivation below except I remove an important difficulty by defining a different wavelength. Compton describes an electron-wave Bragg type diffraction grating with planes separated by ½ deBroglie wavelength composed of standing waves of the wave function Ψ. In the light-charge interaction the Bragg grating recoils causing a Doppler shift in the Bragg reflected electromagnetic wavelength. In that Bragg reflection model they use a stationary frame component of the standing wave. However, there is no experimental justification toward modeling a stationary frame Ψ of comparable amplitude to the recoiling Ψ component, which together could generate an appreciable standing wave. Such a laboratory frame charge-wave can be going in any direction such that its addition to the forward component charge-wave would create a very weak plane of standing wave to reflect light. My model postulates, with experimental justification after making this postulate, that there is a fundamental nonlinearity in a Ψ medium that creates envelopes of charge-wave, and that this envelope has the wavelength:
λ_{g}=(h/mₑ)/υ_{g}, Eq. (3)
where λ_{g} is the wavelength of an envelope of Ψ, and υ_{g} is the velocity of the charge-wave envelope. Eq. (3) looks like the deBroglie equation but differs in the meaning of its terms. Numerically mₑ the same as the mass of the electron, but I ask that it be viewed temporarily as the mass of a three dimensional envelope of charge-wave. Later I show why h/mₑ is written together. deBroglie's equation uses the wavelength of the Ψ wave, where in Eq. (3) 1 use the length of an envelope of the Ψ wave. In G P Thomson's book, The Wave Mechanics of Free Electrons (1930) pg. 127, in an analysis of work by C G Darwin, he states: “ . . . observing the heterodyne waves instead of the original wave train. It does not, however, affect questions of wave-length or of the motion of the original particles.” Here the expression for the motion of the particles may be understood in the usual quantum mechanical sense as detection events. G P Thomson had considered the envelope interpretation, of which I have developed, and found it consistent with charge diffraction experiments. However, in exploring the works of Darwin, Thomson, and others, no one used a group length in the wave-length equation; deBroglie's version used the wave length of Ψ.

My use of forward moving wave groups implied by Eq. (3) removes the stationary frame component required to create standing waves. I do use a standing wave model in the atom, but the atom is not needed for Compton scattering. To be accelerated by an incident x-ray in one direction I model electrical charge to be free from or in a loose bond with the atom. Bragg reflection from standing waves of Ψ in charge of atomic bonds also explains Rayleigh scattering, where there is no wavelength shift. We use the standard Bragg diffraction equation λ_{L}=2d sin(φ/2). Here λ_{L} is the wavelength of light and λ_{g} is the wavelength of a charge-wave group. Solve for d in the Bragg Eq. and insert in Eq. (3), realizing the spacing of the diffraction grating d is the length of charge beats: λ_{g}=d=λ_{L}/2 sin(φ/2)=h/(mₑυ_{g}). Solve for υ_{g} and insert it in the Doppler shift equation Δλ_{L}/λ_{L}=(υ_{g}/c)sin(φ/2). Simplify using sin² θ=(1−cos² θ)/2 to yield Δ_{L}=(h/mₑc)(1−cos φ), the Compton effect equation. The Compton effect is popularly taught using conservation of particle momentum to convey that this effect is strong evidence for particles. The only thing remotely particle-like in the above derivation were the h and mₑ terms. Notice the Compton equation contains ratio h/mₑ=Q_{h/m}. This ratio, and similar ratios of h, e, and m, are always present describing wave property experiments on charge. The ratio allows action and mass to individually become less dense, to thin-out, while the ratio itself is preserved. We do not measure h or mₑ in this experiment; only the ratio Q_{h/m}. So the message of the experiment should be written Δλ_{L}=(Q_{h/m}/c)(1−cos φ). To summarize my version of the loading theory, nature expresses particle-like properties when the wave reaches the h threshold value, and expresses the wave properties by keeping this Q ratio constant as the wave spreads out. If we go back to Planck's 1911 paper and use action instead of energy as the variable that reaches a threshold, the results of his derivation will be the same.

In my search, all attempts to generate the photoelectric effect equation have used the concept of quantization of energy in the electromagnetic field, the photon. The photon model of Einstein “On a heuristic point of view concerning the production and transformation of light” (title translated) Ann. d. Phys. 17 (1905) pg. 132, gained popularity because the photoelectric effect equation fits experiment. If a model generates an equation that fits experiment, it does not eliminate the possibility that another model can generate the same equation. However, our textbooks always use particle models to derive the photoelectric and Compton effects, and then use experimental confirmation of the equation to attempt to prove that the effect requires the particle model. Sommerfeld in his book Wave Mechanics (1930) pg. 178 describes Einstein's photoelectric effect law as “not actually derived.” To my knowledge, no one has linked the photoelectric equation to the deBroglie equation in any derivation similar to mine, as I show below.

To show that a particle model is not required, my derivation uses the charge-wave envelope model. This model is also similar to a description found in Schrödinger's famous paper “Quantization as a problem of proper values,” Annalen der Physik (4), vol. 79 (1926). The Balmer equation of the hydrogen spectrum reveals that the light frequency v_{L} is the result of the difference between two frequency terms v_{Ψ}. In its simplest form the Balmer equation can be expressed as:
v_{L}=v_{Ψ2}−v_{Ψ1}. Eq. (4)

From these difference frequencies, plus Schrödinger's suggestion that light interacts with the beats, I use a trigonometric identity:
Ψₜₒₜₐₗ=Ψ₁+Ψ₂=cos 2π[(x/λ_{Ψ1})−v_{Ψ1}t]+cos 2π[(x/λ_{Ψ2})−v_{Ψ2}t]=2 cos 2π[(x/λ_{Ψa})−v_{Ψa}t]cos 2π[Δ(1/λ_{Ψ})x/2−Δv_{Ψ}t/2]
where the second term in the right hand side is a modulator wave at frequency Δv_{Ψ} that shapes the first term, an inner average Ψₐ wave. From this model, we count the two beats (groups) of Ψ per modulator wave and realize the modulator wave frequency Δv_{Ψ} equals the light frequency: Δv_{Ψ}=v_{L}. This is all done just to show that the frequency of two beats of charge envelope fit the frequency of a light wave, where light is the modulator term in the trigonometric identity. In terms of frequency:
2v_{L}=v_{g}. Eq. (5)
For anything periodic, including beats, velocity equals frequency times wavelength. Substitute Eq. (4) and Eq. (5) into υ_{g}=v_{g}λ_{g} to get:
mₑυ_{g}²/2=hv_{L}, Eq. (6)
which is the equation for the photoelectric effect as it would occur at the atomic scale. The term for escaping a potential is an obvious refinement.

The photoelectric effect experiment does not actually deliver all the information expressed in Eq. (6). We may measure frequency and velocity, or equivalently we may measure frequency and electrical potential, but we borrow the electron charge e or its mass mₑ from different experiments. The message of the photoelectric effect experiment, independent of other experiments, must be written:
υ_{g}²/2=Q_{h/m}v_{L}, Eq. (7)
where Q_{h/m}=h/mₑ. When the wave spreads in free space we only read the various ratios of action, mass, and charge in our experiments. In free space the Q ratios are the constants, and h, mₑ, and e are maximums that we have individually deciphered only through experiments using condensed matter. Similarly Eq. (3) should be written λ_{g}=Q_{h/m}/v_{g}, to account for the spreading wave and a mechanism for the loading effect. The Q ratios I mentioned are Q_{h/m}=h/mₑ, Q_{e/m}=e/mₑ, and Q_{e/h}=e/h. In wave experiments with associated equations containing these ratios, we only measure the Q ratio.

Experimental evidence of the unquantum effect shown in this disclosure would not be detectable if electromagnetic energy was generally quantized. The theory I developed above, with energy thresholded by matter (energy with rest-mass) instead of being generally quantized, led me to predict the design of experiments in this disclosure. The threshold concept explains the spreading wave by allowing a thinning-out of charge, mass, and action, keeping them in proportion, while explaining particle-like absorption by threshold events. In contrast, quantization requires a nonphysical wave function that exceeds the speed of light.

In developing the concept of a wave associated with particles, deBroglie derived his famous relation
h=mₚυₚλ_{Ψ}, Eq. (8)
where mₚ is total relativistic particle mass, υₚ is particle velocity, and λ_{Ψ} is phase wavelength of a matter wave function Ψ. After Eq. (8) was endorsed by Einstein, used by Schrödinger, and shown to be consistent with electron diffraction experiments, the equation was routinely used. The mixture of wave and particle terms in Eq. (8) inescapably preserves the conceptual difficulties of wave-particle duality in quantum mechanics. Intimately linked to the derivation of Eq. (8), deBroglie assumed a matter frequency v_{Ψ} using the relations:
εₚ=mₚc²=hv_{Ψ}, Eq. (9)
where εₚ is mass-equivalent energy plus kinetic energy of a particle.

Notice that this association of h with a matter-frequency v_{Ψ} is very different from its use connected to any experiment; we never measure this matter frequency. When h enters analysis of black body, photoelectric, Compton effect, and other experiments, h relates to kinetic energy or momentum. The link between Planck's constant and mass-equivalent energy has only entered our conceptual framework through this great leap of faith made at Eq. (9). With this overview, our experiments are telling us that h is really about kinetic energy, not mass-equivalent energy. From deBroglie's early books, such as An Introduction to the Study of Wave Mechanics (1930), one can see that Eq. (9) came from a symmetry argument using the wave-particle dualistic model of the photoelectric effect as a starting point. Using Eqs. (8) and (9), put v_{Ψ} and λ_{Ψ} into υ_{Ψ}=v_{Ψ}λ_{Ψ}. This leads to
υₚυ_{Ψ}=c² Eq. (10)
where υ_{Ψ} is phase velocity of a Ψ probabilistic matter wave. Alternatively, one can use dimensional analysis on the Lorentz transformation of time to extract Eq. (10) to derive Eq. (8) However, this only works if one fails to distribute the 1/(1−υₚ²/c²)^{1/2} term. For arbitrarily slow particles, Eq. (10) implies arbitrarily fast Ψ velocities. A stationary particle implying infinite velocity should have warned physicists that there was something very wrong with the derivation of the deBroglie equation and quantum mechaincs. Instead of taking a warning, Eq. (10) is used often in our modern textbooks and famous literature to show T is not physical; see for example M Born Atomic Physics (1935) pg. 89. If we assume the Ψ wave is not just a pure mathematical convenience (if we assume a physical Ψ), and any version of special relativity, the specific form of either Eq. (8) or (9) or both must be abandoned.

Returning to the Compton effect, a famous test was the experiment of Bothe & Geiger, where an x-ray beam interacting with hydrogen is measured for coincident electron and x-ray photoelectron events. The experiment was intended to test if a wave model developed by Bohr, Kramers and Slater could serve as an alternative to quantum mechanics. The theory of Bohr et al was about spherical x-ray wave fronts that induced electron events on a statistical basis whereby momentum was only conserved on the average and not for each electron event. The statistical nature of the theory predicted that electron events would not synchronize to photoelectron events. The analysis by Bothe and Geiger of their experiment showed that the rate of synchronized events happened more often than chance, but not as often as would be expected from a purely particle model either. The partial particle-like results of the Bothe-Geiger experiment was enough to shoot down the Bohr et al model, and all writings afterward took on an even stronger particle-biased attitude. From examining the original work in German, the assessment by Bothe and Geiger was only reservedly in favor of the particle model of Compton, since their data showed that only sometimes the events are synchronized, and mostly they are not. From the Bothe-Geiger experiment, approximately only one in 2000 events were simultaneous before calculating detector inefficiency, and the corrected rate is 1/11. If particles were the cause this rate would be much higher. Many experiments have been done to research simultaneity in the Compton effect. Except for the 1936 work of Shankland, “An apparent failure of the photon theory of scattering,” Physical Review 49 (1936) pg. 8, all works thereafter, as evidenced by a review article by Bernstein and Mann, “Summary of recent measurements of the Compton effect,” American Journal of Physics 24 (1956) pg. 445, missed the point, and concentrated instead on how many nanoseconds within which a pair of events are simultaneous. My research found no report later than 1936 gave any number for the degree of simultaneity among electron-photon events.

Importantly, our literature is flooded with commentary on the results of this experiment that falsely report a one-to-one correspondence between photon and electron events. A similar situation persists in the way the scientific community has misrepresented the message of the data of the Compton-Simon experiment.

Here I will show that data from Bothe, Geiger, “Uber das Wasen des Comptoneffekts,” Z. Phys. 26 (1924) pg. 44, fits my wave model. The electron detection rate was 6 e/s=Iₐ, but this detector was 200 times more efficient than the x-ray detector. The window of simultaneity τ was 1 ms. Using the equation for shot noise Iₙ(2Iₐe/τ)^{1/2},
Iₙ=[(2)(6e/s)/(10⁻³e/s)]^{1/2}=115e/s. Eq. (11)
This gives IₐIₙ=6/115, 20 times more noise current than the average current. Accounting for the factor of 200 detector inefficiency gives 4000 events/coincidence. Since each detector picked up only half a radiated sphere, divide by two to get 2000 events/coincidence, which matches data from the experiment. Shot noise shows that the observed simultaneity is what would be expected from this type of beating spreading wave. Detector inefficiency or multiple scatterings have not accounted for the low coincidence rate.

The issue of simultaneity in the Compton effect is a good example of how a particle-biased mindset has influenced the transmission of information from experiment to our textbooks. In a paper by Compton and Simon, “Directed quanta of scattered x-rays,” Physical Review 26 (1925) pg. 289, in their abstract they write: “It has been shown by cloud expansion experiments previously described, that for each recoil electron produced, an average of one quantum of x-ray energy is scattered by the air in the chamber.” Amazingly, even Compton in his Scientific American article, “What things are made of” February 1929, p. 110, and most authors afterwards, did not accurately relay the message of this experiment to us, saying that momentum is conserved in “each” detector event, like macroscopic balls. A billiard-like model is unfounded because the average nature of the effect was demonstrated by the high rate of non-simultaneous events recorded in both the Compton-Simon and the Bothe-Geiger experiments.

I will only mention here some of my other equally strong analyses where I have shown the charge-wave works and quantum mechanics leaves questions. I derived Planck's black body distribution using charge beats instead of standing waves of light. Most of our textbooks use a standing wave of light model to derive the Planck distribution, even though Planck did his derivation using Hertzian oscillators, not light, as stated in his 1906 Theorie Der Warmestrahlung, and all his books. The fact that cosmic microwave background radiation obeys the black body distribution makes it clear that standing waves of light cannot possibly be at play. There are no mirrors making the standing waves. Such a thing would require the whole universe to act as an absurd perfect laser cavity. Further analyses of mine has addressed the folly of assuming charge must be quantized in free space, based upon Millikan's oil drop observation of quantized charge in a macroscopic oil drop. Also, the charge-wave model derives antimatter by reversing the phase of the Ψ wave within the envelopes. It is important to mention these flaws in quantum mechanical arguments because physicists are convinced that quantum mechanics must be true, and my discovery shows how it is not true.

The most common and most important misleading idea to be found in our literature concerns response time in the photoelectric effect. The treatment given in the popular text Fundamentals of Physics second edition extended by Halliday and Resnick (H&R) is typical of many textbooks and articles. Given a light source and the size of the atom one can calculate the time that the atom should take to accumulate enough energy to eject an electron. The student calculates some number of hours, and the text then cites a much shorter response time on the order of a nanosecond obtained experimentally. The experimental source most often cited is Lawrence and Beams (L&B), “The element of time in the photoelectric effect, “Physical Review 32 (1928) pg. 478. The light flux L&B used was not stated. Our textbooks explain that “no time lag has ever been detected.” From L&B's data, their minimum response time was about 3 nanoseconds, and the average response time was about 30 ns. There are two problems. Since L&B did not report incident light flux, one cannot compare their response time to arbitrary givens in a homework problem. The other problem is that by H&R stating “no time lag has ever been detected,” it falsely represents the results of the experiment, which does report an average time lag. An average time lag is consistent with the idea of a pre-loaded state, but this idea was not given a chance when they denied any form of time lag. Consideration of the pre-loaded state seems to have been banished from our literature ever since Millikan considered it in Electrons (+ and −); since then every book or article I could find is written with the unstated assumption that an accumulation starts from zero when the light is first applied. If a pre-loaded state is allowed to exist it is easy to use a classical calculation, the average response time, and conservation of energy to calculate a reasonable incident energy flux in the L&B experiment. Authors should write: no minimum time lag has ever been detected. By stating that “no time lag” exists when in fact an average time lag does exist, textbook authors have effectively propagandized photons.

With this above outline of long standing conceptual problems in quantum mechanics, errors perpetuated in our textbooks, and seeing that the photoelectric effect and the Compton effect can be derived with waves, my evidence for an unquantum effect disclosed here is made reasonable in the context of past physics.

### Comparison to Prior Art

In Givens' 1946 beam splitter test, a Coolidge x-ray tube was used, which at any normal operating rate would generate many overlapping Gaussian pulses, each with hv electromagnetic energy. Such envelopes attenuated by distance and apertures would average out to a smooth energy flux, greatly lowering the chances that a hv pulse could trigger coincidences surpassing the chance rate. The wide-band emitters and detectors used by Givens, would further obscure a classical pulse response. Givens used Geiger-Mueller counters which do not deliver a pulse proportional to the electromagnetic frequency of the incident radiation. Furthermore, no pulse amplitude analysis or discriminator levels were reported. My method takes advantage of modern detectors that deliver a pulse amplitude substantially proportional to electromagnetic frequency to establish the relationship between source and detection events. Without establishing this relationship between source and detector events, the resulting measured events in both detectors will not show coincidences due to different times that a tuned microscopic absorption oscillator would reach threshold in the presence of a wide range of frequencies. Furthermore, my method takes advantage of pulse-like single hv emission from radioactive decay. Also I use a low count rate to prevent overlapping classical pulses from smoothing the pulse-like spatial and temporal quality of the energy flux. The test by Givens was inadequate to make a quantum/classical distinction.

Clauser, and all others attempting this beam splitter test have made a crucial error concerning the PMT. Even if the source of light is monochromatic, the PMT will generate a wide distribution of pulse amplitudes. The typical pulse amplitude distribution of a PMT is about as wide as the amplitude at the peak of this distribution. In my extensive search of tests of Einstein's beam splitter thought experiment, no publication had specified the range of pulse amplitudes used. However, experimenters always use discriminators to eliminate the small and frequent pulses usually attributed to noise. By eliminating the smaller pulses in the pulse amplitude distribution, it greatly lowers the possibility of detecting coincidences allowed for by the loading theory. Alternatively, if such discriminators are not used, it is not fair with respect to the photon model. Essentially, this type of experiment cannot make a fair classical/quantum distinction using optical light and PMTs because the PMT delivers too wide a distribution of pulse amplitudes in response to monochromatic light.

Another important oversight in Clauser's experiment is that he describes using a polarizing beam splitter. Data from C A Kocher and E D Commins, “Polarization correlation of photons emitted in an atomic cascade,” Physical Review Letters 18 (1967) pgs. 575-577, show that single hv emissions from atoms are polarized. A randomly polarized pulse of light will be unequally split by a polarizing beam splitter, thereby lowering the opportunity for coincidences. This would unfairly eliminate the classical alternative, the experiment was supposed to distinguish from quantum mechanics. This flaw, plus false assumptions concerning the PMT, voids Clauser's result.

In my research of over a hundred articles directly referencing Clauser's 1974 paper, including Grainger et al's 1986 rework, and Clauser's own recent articles, these important technical oversights concerning the detector resolution and polarized beam splitter have remained uncorrected.

### Non-Obviousness of the Invention

One would think that it would be obvious to try the beam splitter test with gamma rays to show how to defy quantum mechanics. Einstein's beam splitter thought experiment has been well known since 1927. However, the way to select, adjust, beam, split, and detect an energy that obeys E=hv, and split it in a manner that breaks chance has never before been accomplished. This situation has persisted even though many brilliant researchers have objected to the strange ways of quantum mechanics and have searched for ways to disprove it. No one has previously considered using the most particle-like light to show that light is not particles. Everyone takes it as a fact that gamma rays are photons. For example, a well respected book edited by K Siegbahn Alpha Beta and Gamma-ray Spectroscopy (1962) contains the article by C M Davison “Interaction of γ-radiation with matter” with the opening line “The interaction of γ-radiation with matter is characterized by the fact that each γ-ray photon is removed individually from the incident beam in a single event.” If gamma rays were photons, my experiments would not break chance.

No one has previously developed any viable alternative to the photon model that can account for the particle-like effects. To visualize a way that classical light can break chance in the beam splitter test requires an understanding: (1) how an electromagnetic emission could be emitted in a pulse like fashion to defy chance in the beam splitter experiment, and (2) how a preloaded state could deliver the illusion that a particle hit there. It requires understanding how an electromagnetic pulse of initial energy hv could split as a wave and cause coincidences. It requires understanding how a set of oscillators at random levels of a partially loaded state could be fed energy in a continuous fashion, and how the time to reach a threshold of fullness in a loading mechanism would be random. To break chance, it requires understanding how a classical electromagnetic pulse with energy less than or equal to hv may be partially absorbed by separate resonant absorbing centers, and then trigger coincident loading to threshold hv at these absorbing centers at rates surpassing chance. To solve this very difficult puzzle required all the theory I outlined in the THEORETICAL BACKGROUND section.

From my theoretical work and historical analysis up to year 2000, I knew that a source emitting strong individual hv bursts was needed; with that knowledge it was obvious to try gamma rays. My early attempts to search for the unquantum effect with the simple idea of using gamma rays were failures. My first gamma ray attempt using the radioisotope Na22 was totally inappropriate because it creates what are called true coincidences. Tests with Cs137 and other popular gamma ray sources only gave chance. The unquantum effect only showed itself after I had developed the method to a much more sophisticated level involving the choice of specific properties of the source, detector, and the relationship of source and detector to each other. There were many obstacles to overcome: (1) in choosing a gamma source, there must not be other gamma, or other forms of radiation, emitted simultaneously with the gamma frequency under study that has an equal or higher frequency, and there are very few available gamma sources that emit one characteristic gamma ray; (2) there are very few gamma sources available in the spectral section of high photoelectric effect efficiency for the high resolution detectors; (3) an initially unrecognized contaminant in Cd109 caused a peak at exactly 3 times the fundamental 88 keV of Cd109 and emitted frequencies that hid an expected 2×88 keV anomalous sum peak; (4) the highest resolution detectors have lower photoelectric efficiency, so in a situation that a scientist would normally think they see better, they see worse; (6) a fluorescence from lead fell at nearly the same keV as the 88 keV of Cd109, which could confuse interpretation; (7) I had no support from any physicist because they all knew gamma rays acted like particles.

There is no way to explain my findings with quantum mechanics. No one else has ever broken chance in the beam splitter test to show particles must not be the cause, no one else has ever performed the beam splitter test using gamma rays, and of course no one else has ever used such a discovery to launch a new form of spectroscopy.

### BRIEF DESCRIPTION OF THE FIGURES

FIG. 1 shows the pulse amplitude response of a typical photomultiplier tube responding to visible light.

FIG. 2 show annotated pulse amplitude spectra, using Cd109, Co57, and a high resolution germanium type detector.

FIG. 3 show annotated pulse amplitude spectra, using Cd109, Co57, and a sodium iodide type detector to study sum-peak details.

FIG. 4 shows a preferred embodiment of this invention with one detector in front of another in tandem geometry.

FIG. 5 shows detail of detectors used for selected tandem geometry experiments.

FIG. 6 shows a section of screen capture from my oscilloscope of a coincidence time plot (Δt plot), using Cd109, and detectors described by FIG. 5 in tandem geometry.

FIG. 7 show coincidence time plots, using Cd109, Cs137, a signal generator, and sodium iodide detectors in tandem geometry.

FIG. 8 show coincidence time plots, using Cs137, and sodium iodide detectors in tandem geometry to study effects of distance and attenuation.

FIG. 9 show coincidence time plots, using Co57, and sodium iodide detectors in tandem geometry to study effects of distance.

FIG. 10 shows a coincidence-gated pulse amplitude plot (histogram), using Cd109, a high resolution germanium detector, and a sodium iodide detector in tandem geometry. A singles spectrum of Cd109 is also shown.

FIG. 11A shows a section of screen capture from my oscilloscope of coincidence time plots, using three preparations of Cd109 in different crystalline states, and sodium iodide detectors in tandem geometry to study effects due to chemical state of the source.

FIG. 11B shows a section of screen capture from my oscilloscope of coincidence-gated pulse amplitude plots, using the same three preparations of Cd109 used in FIG. 11A, and sodium iodide detectors in tandem geometry to study effects due to chemical state of the source.

FIG. 12 shows a preferred embodiment of this invention in beam splitter geometry equipped to adjust the angular orientation of a detector and the angular orientation of a material scatterer under study.

FIG. 13 show coincidence time plots, using Cd109, and two sodium iodide detectors in beam splitter geometry to study a silicon material scatterer at two angular orientations.

FIGS. 14A and 14B show the relative size and orientation of two high resolution germanium detectors, source, and magnet assembly used in the tests of FIGS. 15 and 16.

FIG. 15 show coincidence-gated pulse amplitude plots, using Cd109, and two high resolution germanium detectors in beam splitter geometry to study a ferromagnetic scatterer in different magnetic fields.

FIG. 16 shows a section of screen capture from my oscilloscope of coincidence-gated pulse amplitude plots, using Cd109, and two high resolution germanium detectors in beam splitter geometry to study a diamagnetic scatterer in different magnetic fields.

FIG. 17 shows the beam splitter geometry relating to plots in FIGS. 18 and 19.

FIG. 18 shows a section of screen capture from my oscilloscope of coincidence-gated pulse amplitude plots, using Cd109, and two high resolution germanium detectors in beam splitter geometry to study an aluminum scatterer at different temperatures.

FIG. 19 shows a section of screen capture from my oscilloscope of coincidence time plots, using a salt state Cd109, a metallic state Cd109, and two sodium iodide detectors in beam splitter geometry to study differences from these two sources upon a germanium scatterer.

FIG. 20 shows annotated pulse amplitude spectra, using a sodium iodide detector to study the same two sources used in the test of FIG. 19.

### DETAILED DESCRIPTION OF THE INVENTION

Introduction

My earliest successful evidence of the unquantum effect dates from Aug. 8, 2001, with hundreds of experimental variations and upgrades performed since then. This invention relates to the method of achieving, measuring, and applying the unquantum effect in physical measurement.

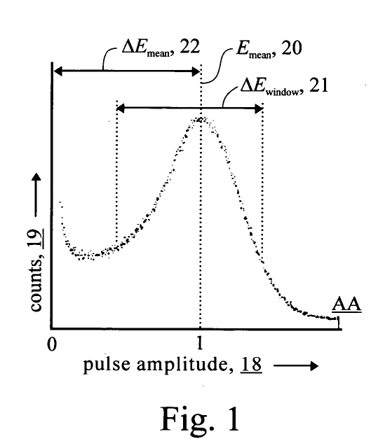

A distinguishing element my method provides over prior art is to use a detector with substantial pulse amplitude resolution in response to the type of radiation being measured. This phrase, substantial pulse amplitude resolution, implies two things: (1) the pulse amplitude is proportional to the electromagnetic frequency of the incident radiation, and (2) the distribution of pulse amplitudes in response to a given frequency of incident radiation is narrower than the mean pulse amplitude. Historically, experiments with the DuMond curved crystal spectrometer design of 1927 have confirmed the relationship between detector pulse amplitude and electromagnetic frequency. As mentioned in the COMPARISON TO PRIOR ART section, a photomultiplier tube used with visible light does not deliver a good enough pulse amplitude resolution. FIG. 1 shows a typical pulse amplitude distribution AA of a PMT from a data book from Phillips Photonics, Photomultiplier tubes principles and applications, (1994) pg. 2-8, with my annotations added. This distribution was similar to my own test with a red laser and a PMT. FIG. 1 graphs pulse amplitude 18 verses counts 19, with the peak of the distribution at pulse amplitude Eₘₑₐₙ 20, and the full width of the distribution ΔE_{window} 21. The boundaries of ΔE_{window} 21 are typical positions for discriminator settings, also known as a single channel analyzer (SCA) window. Span ΔEₘₑₐₙ 22 of pulse amplitudes up to point Eₘₑₐₙ 20 is about the same distance in this case as span ΔE_{window} 21. Here we see what a typical experiment using a PMT must work with. If the window was set so that ΔE_{window}≧ΔEₘₑₐₙ in a beam splitter test, events in coincidence would be recorded too easily and would overshadow coincidences gamma-triggered by a classical pulse in a loading scheme; it would not be fair to the loading model. On the other hand, if we were to assume a photon model and were to set the SCA window narrower so that ΔE_{window}<ΔEₘₑₐₙ, too many events that could have been triggered by a photon would have been eliminated from being detected in coincidence; it would not be fair to the photon model. In other words, a beam splitter test cannot make a distinction between a probability wave and a classical wave using a detector/source combination unless ΔE_{window}<ΔEₘₑₐₙ. This is the importance of substantial pulse amplitude resolution. A PMT does not have substantial pulse amplitude resolution. The detector that I usually use is a NaI(Tl) scintillator coupled to a PMT; these detectors working above ˜40 keV satisfy this criteria and do have substantial pulse amplitude resolution. This is the most important reason why my method gives the opposite result compared to the result of prior art. To my knowledge, no prior art attempt at the beam splitter test has used a detector with substantial pulse amplitude resolution; neither have they bothered to report discriminator or SCA levels.

Indeed, there is great confusion over the interpretation of what a PMT delivers. Physicists generally think, to their great error, that the pulse delivered by a PMT is proportional to the frequency of the incident light; as evidence I quote RP Feynman QED (1985) pg. 15: “ . . . clicks of uniform loudness are heard each time a photon of a given color hits plate A.” A distribution of click loudness that is as wide as the mean loudness is not a click of uniform loudness. This quote also demonstrates the false assumption: a photon is a thing existing prior to the detection event.

The method of this disclosure specifies two preferred embodiments that are currently functional in my laboratory. There are two geometries described in my experiments and embodiments: a beam splitter geometry and a tandem geometry. In tandem geometry, with one detector in front of another, the first detector performs the function of both the beam splitter and detector, and shows the effect more efficiently. Several variations on the theme of splitting a gamma ray using each of these geometries have been accomplished.

It is necessary to make clear that notation eV for electron volts, or keV for kiloelectron-volts, is used here only for convenience to the reader. eV is a photon concept. Where a conventional physicist would describe photon energy, I may describe frequency or detector pulse amplitude instead. If gamma rays are not photons, we should talk of frequency instead of energy. In conventional physics hv is often used to describe a photon energy. However, in the context of this disclosure hv is an energy proportional to frequency: (a) in matter at a threshold, and (b) in an initially emitted burst of electromagnetic energy. In the context of this disclosure a quanta is an hv of energy at an internal threshold, or at an initial release of light. After the quanta is released as light it does not remain quantized. An absorption or detection event is modeled as a resonant loading in an electronic oscillator, whereby the event occurs when a threshold is met within the electronic oscillator at energy hv. My beam splitter experiments with gamma rays show, it is not always the same pulse of energy hv emitted from the source as the hv absorbed at the detector because it breaks chance.

Comparing a chance coincidence rate R_{c} with an experimentally measured coincidence rate Rₑ, distinguishes between classical and quantum mechanical models of light. If light really consisted of photons, or equivalently, if light always deposited itself in a photon's worth of energy, it would be a quantum mechanical wave function Ψ that would split, and the particle would go one way or another. After absorption the wave function would need to magically collapse. The consensus among all experimental prior art works I have cited who have performed the beam splitter test, and surely among most physicists is: the only source of coincident detection events from individually emitted quanta is chance. The embodiments demonstrate E=hv applies to matter as a loading effect, and E=hv cannot be due to a quantum mechanical property of light.

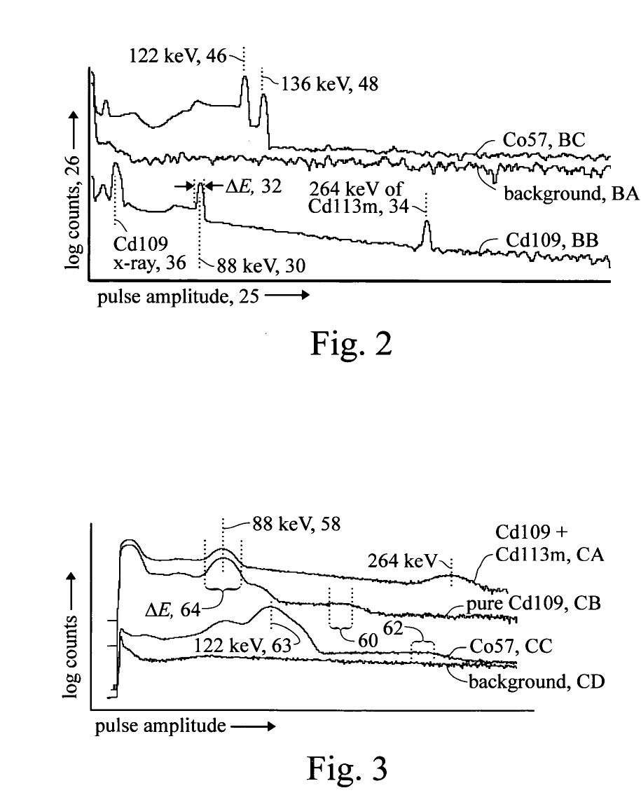

Two radiation sources have been found highly successful in measuring the unquantum effect: 88 keV gamma rays from cadmium-109 (Cd109) and 122 keV gamma rays from cobalt-57 (Co57). In both of these radioisotope sources, spontaneous nuclear decay is understood to occur in an electron capture process. Two detector types have been highly successful in detecting the unquantum effect: sodium iodide scintillator crystals doped with thallium, NaI(Tl), and high purity germanium (HPGe) detectors. FIG. 2 shows detector pulse amplitude spectra taken in my laboratory June 2003 using my HPGe detector, with scales pulse amplitude 25 and logarithmic scale of counts 26. In most of my plots the vertical scale is offset to superimpose many plots on the same horizontal scale. The detector is a CANBERRA GR1520 reverse electrode type. To minimize background radiation, all measurements for spectra and plots reported in this disclosure were taken within a lead shield of my own fabrication: a cylinder 12 inches diameter, 15 inches long, with 2 to 3 inch walls of lead, lined with 2 mm of tin and 3 mm copper at the inside walls. In the range 56 to 324 keV the average background rate in the shield was lowered to 1/31 of that read outside the shield.

FIG. 2 show spectra of background BA, and Cd109 BB. The 88 keV 30 gamma ray from Cd109 is a characteristic detector pulse amplitude. We know gamma rays only through characteristics revealed in experiments. In the physics of this disclosure, the atom emits an initially directed classical pulse of electromagnetic energy at an electromagnetic frequency. Typical emitted bandwidths are known from other experiments to be much narrower than the bin widths of the spectra in my instruments. For this Cd109 characteristic gamma ray emission, the detector responds with pulse amplitudes within range ΔE 32. From taking spectra like these on FIG. 2 one can determine the electromagnetic frequency of the gamma ray and rates at which they are produced, but one cannot conclude that a photon left the atom and landed at the detector.

It was discovered that Cd109 is often contaminated with Cd113m (m=metastable) that produces a 264 keV peak 34 and a continuum from 88 to 264 keV. By using a later obtained source of Cd109 that was free of any detectable Cd113m and repeating a coincidence test, I confirmed that this contamination was not distorting coincidence counts in my experiments using two detectors. Cd113m did not create coincidences by Compton downshifting or any other mechanism. An x-ray 36 is also radiated by Cd109. A lower frequency from such an x-ray cannot by any known mechanism lend to producing coincidences near the 88 keV section. Tests with a 2 mm aluminum filter to attenuate the x-ray showed no change in the unquantum effect. Spectrum BC of Co57 shows two gamma peaks, at 122 keV 46, and 136 keV 48. Published energy level diagrams devised from coincidence tests show there are separate pathways for these two frequencies, which means gamma rays 46, 48 occur independently. NaI(Tl) detectors cannot resolve these 46, 48 peaks. Therefore a coincidence test using NaI(Tl) detectors windowed over both 46, 48 gamma frequencies can be treated as if only one hv was emitted at a time. Other high resolution detectors such as Cadmium Zinc Telluride should also work well.

There are two important absorption mechanisms in these discussed detector materials: the photoelectric effect and the Compton effect. For the two isotopes that the unquantum effect easily reveals itself, it has been found that the photoelectric effect dominates. Most tests in this disclosure used a NaI(Tl) scintillator coupled to a photomultiplier tube. In sodium iodide scintillator detectors reading 88 keV gamma rays emitted by Cd109, the photoelectric effect dominates over the Compton effect by a factor of 18. However using HPGe detectors this ratio is 4.6. This information is from graphs published by NIST generated from quantum mechanical calculations. This dominance of the photoelectric effect is similar with 122 keV from Co57 when comparing the two detector types. Also, at 88 keV, NaI(Tl) detectors have a peak in overall absorption efficiency. From studying this I predicted that the unquantum effect would be more easily seen with NaI(Tl) than HPGe detectors; this tested true from examining sum-peaks in single detectors and comparing them in both detector types.

The unquantum effect is most easily seen with a single detector by carefully measuring the sum-peak that is produced by pile-up of pulses. The sum-peak is found at twice the pulse amplitude of the normal gamma ray. In this technique the detector material serves the purpose of detector, beam splitter, and coincidence gate. The beam splits within the body of the detector. The summing of light pulses within the scintillator serves the function of coincidence-gate electronics explained for the preferred embodiments. FIG. 3 shows logarithmic spectra of gamma ray emitting sources read with a 2×2 inch cylindrical BICRON brand NaI(Tl) detector read with a commercial multichannel analyzer, and with the sources placed at the top of the detector taken October 2004. Plots are of: ˜5 μCi of contaminated Cd109 due to Cd113m at plot CA, ˜5 μCi of substantially pure Cd109 CB, ˜5 μCi Co57 CC, and background CD. Here we see how the usual presence of Cd113 could easily hide an anomalously large sum-peak. A sum-peak is usually attributed to chance, and its amplitude is predicted by calculating the chance sum-peak rate:
R_{cp}=2τR² Eq. (12)
where τ is the time span of each pulse that piles up, and R is the rate at the peak of the distribution that piles up to cause this sum effect. There is some controversy in the literature over the accuracy of this equation and how to choose the value of τ. I have circumvented this problem by doing an experiment with Cs137 under conditions that display no unquantum effect, and used Eq. (12) to calculate τ=1.16×10⁻⁶ sec. The shape is conserved with different amplitudes, so this time constant is also conserved.

The bin with the highest rate at 88 keV 58 in pure Cd109 gave R=74.3/s. From Eq. (12), R_{cp}=0.0064/s. For the experimentally measured sum-peak rate, Rₑ, an average was taken in the marked section 60 surrounding 2×88 keV, and an average of the background at this spectral section was subtracted, giving Rₑ=0.064/s. The ratio of [measured sum-peak rate]/[chance sum-peak rate] gives the degree that chance is exceeded, and is calculated: Rₑ/R_{cp}=10×chance.

Similarly for Co57, examining section 62 at 2×122 keV, the singles rate at 122 keV 63, and τ gave Rₑ=2(1.16 μs)(67.8/s)²=10.7×10⁻³; Rₑ/R_{cp}=0.0107/0.00196≈5.5×chance. This roughly tracks the idea that the effect is due to photoelectric dominance, which is less at 122 keV. These enormous spectral components cannot be explained by any way one calculates the chance sum-peak. They have only been observed in Cd109 and Co57, and are very easy to demonstrate. These sum-peak areas are shaped more like plateaus than peaks. In my research I explained this shape by writing a simulation program that input the whole spectral region of characteristic gamma and Compton shifted components. A typical SCA window used in my experiments is shown at ΔE 64 of FIG. 3.

A more convincing test is to use two detectors one in front of the other, in tandem. In this technique the material of the first detector serves the function of both detector and beam splitter. The components, and most of the techniques described here on using these components are well known in the nuclear measurement industry. What is not known is to understand how to implement these standard techniques to show that detections in coincidence are not caused by incident particles of energy. If they were thought of as particles of energy, an attempt to see two events in coincidence, when there should only be one, would be viewed as a blasphemous attempt to violate conservation of energy. My assertion that my experiments are valid forces a choice between scraping either particles of energy, or conservation of energy. Of course for many good reasons, I uphold conservation of energy. The positive results of my technique forces the realization that these are not detections related to incident particles of energy at all, but are instead a loading effect to a threshold of energy with a loading mechanism related to frequency. Emissions of energy remain as quanta, but thereafter can spread classically.

Preferred Embodiment Using Tandem Geometry

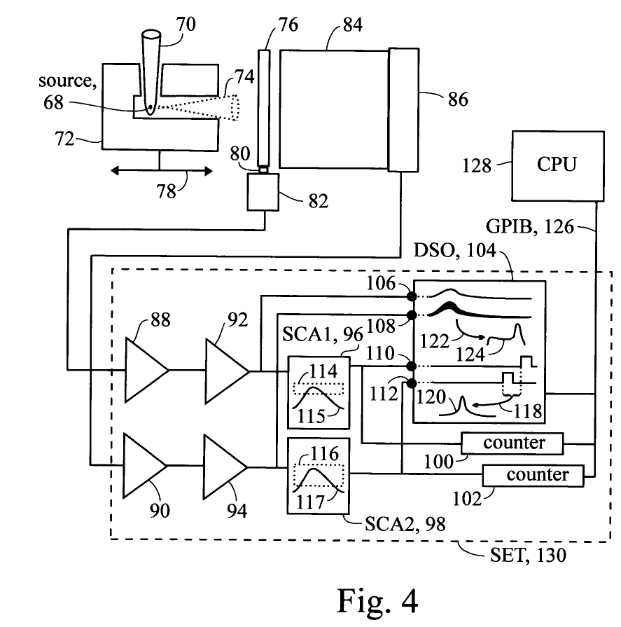

The preferred embodiment of FIG. 4 delivers a robust unquantum effect. It is the simplest to construct and describe, but not the least expensive to build. Specialized forms of this embodiment may be readily devised by engineers familiar with nuclear measurement after studying this specific embodiment. The embodiment of FIG. 4 is useful for demonstrating and researching the unquantum effect under various conditions, distances, and mixtures of source. A useful application of this embodiment would be in the education industry to demonstrate the falsity of the concept of radiant energy quantization. Due to the popularity of photons, and the astounding evidence this embodiment poses against photons, this is a large market.

The entire apparatus should be in a box lined with at least 2 mm of sheet tin, not shown. This was tested to be adequate, but the experiments in this disclosure were all done in my lead shield. In most tests the unquantum effect is clearly apparent without the shield, but by lowering background radiation the shield gives better results. A Cd109 radiation source 68 of at least 1 μCi activity, in holder 70 is mounted in tin collimator 72. Higher activities than 10 μCi are not typically needed in these tests, and such low level sources are available without licensing restrictions. Different preparations of the isotope in salts of different mixture or the isotope in a purified metal state have been found useful to study. The most versatile source holder 70 is a microcentrifuge tube wherein the radioisotope may be most conveniently handled and prepared by starting with the radioisotope in solution, and condensing it to a small pellet under high acceleration to minimize residue sticking to the walls. These radioisotopes are normally available as a salt in dilute solution with water. The detection hardware is best described in two channels. Each channel has a detector, preamplifier, shaping amplifier, and SCA circuit. Collimator 72 serves to define cone 74 of gamma rays aimed toward channel 1 scintillator 76. Collimator 72 is mounted on a linear translation stage 78 that can adjust the distance between the collimator aperture and the face of scintillator 76 over distances ranging from directly adjacent, to typically 6 inches. The strength of the source will determine the thickness of material for collimator 72, the duration of the experiment, and the distance between source 68 and scintillator 76. For a 5 μCi Cd109 source a collimator designed with 5 mm walls of tin works well. If higher frequency gamma sources such as Cs137 are to be tested, a lead (Pb) collimator should be used. In some embodiments there are advantages to construct the collimator with an aperture liner (not shown) made of a different element. Copper lined with tin, and lead lined with tungsten have been tested.

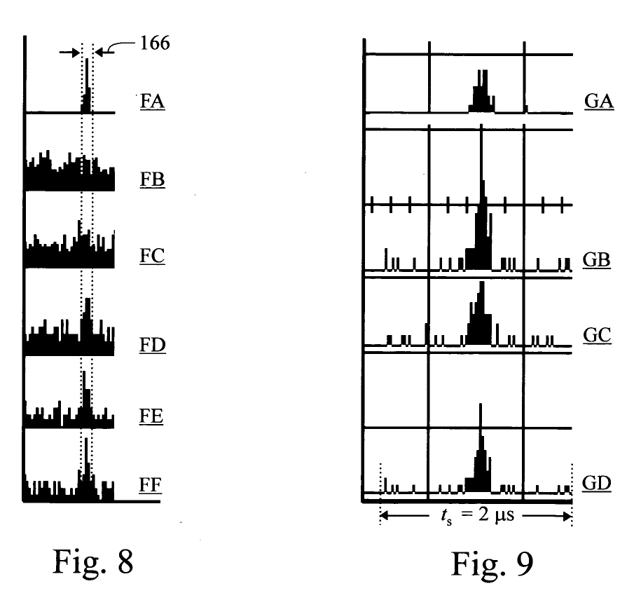

Channel 1 scintillator 76 must be specially designed to be thin enough to allow at least 10% of the incident gamma rays to pass through. The most appropriate design is to use a standard thallium doped sodium iodide scintillator, NaI(Tl), cut as a square thin slab approximately 40 mm long and wide. The thickness is critical. The experiments for FIGS. 8 and 9 have used this same preferred embodiment design with a 4 mm thick×40 mm×40 mm channel 1 detector. This worked well with Co57 and Cs137 but was found to extend the experiment time to about a day when using Cd109. A 3 mm slab is recommended. The slab is packaged and encased in thin aluminum foil, as standard in the nuclear measurement industry for detecting gamma rays. Window 80 at the thin end of scintillator 76 couples light to PMT 82 at its flat photocathode window. Typically, PMT 82 will have a round face, and the drawing does not indicate the true width and length of such a PMT. Scintillator manufacturers can either make a scintillator with its own window 80, or can connect it directly to a photomultiplier tube in a hermetically sealed light tight unit. Channel 2 scintillator 84 is typically a standard 1.5 inch diameter right cylindrical NaI(Tl) scintillator and is normally purchased permanently connected to PMT 86 (not drawn to scale). The aperture of collimator 72 must be narrow enough such that cone 74 does not extend an area larger than that of the far side of scintillator 84 for tests at the greatest extension of translation stage 78. Cone 74 need not be a cone, but can be a beam of any shape defining a solid angle of gamma rays emitted from collimator 72. For just demonstrating that chance can be broken, a collimator is not necessary at all. The collimator is necessary in more sophisticated experiments where the ratio of flux rates between the two detectors is required to remain constant. Another reason for collimating is to reduce scatter within a surrounding shield that lowers radiation from background. Therefore narrowing the solid angle of the beam is optional. The output signals from the photomultipliers are fed to preamplifiers 88 and 90, to amplify the signal approximately a factor of 10 and to limit the amplitude of signals to avoid signal artifacts. The preamplifiers should be located as close to the PMTs as practical, with a shorter wire than that represented in FIG. 4. I found that commercial preamplifiers did not have this limiter feature, and that such a feature was crucial at the preamplifier stage to avoid artifacts; so I designed and built the preamplifier. The simplest method of constructing the preamplifier is to use the LINEAR TECHNOLOGY CORP. LT1222 op-amp which includes the limiter feature, in a conventional inverting amplifier circuit. Signals from each channel are then fed to shaping amplifiers 92, 94 standard in the nuclear measurement industry to deliver shaped pulses that work in conjunction with timing type single channel analyzers SCA1 96, SCA2 98 to deliver digital timing pulses. The specific components for the shaping amplifiers and SCAs used in my experiments, and depicted in this embodiment, are the ORTEC 460 shaping amplifier, and the ORTEC 551 timing SCA, both of which are nuclear instrumentation modules in common use. Digital output from SCA1 96 are counted by counter 100, and digital output from SCA2 98 are counted by counter 102. Counts at counters 100, 102 not in coincidence are called singles. In the experiments, counter 100 generates singles rate R₁ and counter 102 generates singles rate R₂. Use of a digital storage oscilloscope DSO 104 with time analysis and histogram features such as the LECROY CORP. LT344 has been found to be the most versatile and trustworthy method of collecting signals from the shaping amplifiers and SCAs for the remaining analysis. Output of shaping amplifier 92 is connected to DSO-BNC 1 106 (BNC is a connector type), output of shaping amplifier 94 is connected to DSO-BNC 2 108, output of SCA1 96 is connected to DSO-BNC 3 110, and output of SCA2 98 is connected to DSO-BNC 4 112. DSO 104 monitors the analog shaped pulses at DSO-BNC 1 106 and DSO-BNC 2 108 in storage mode for the operator to observe and insure falsely shaped pulses occur less than 1%. DSO-BNC 2 108 is also useful for collecting analog pulse amplitudes for coincidence-gated pulse amplitude plots (histograms).

In preparation of taking coincidence data, a pulse amplitude spectrum of Cd109 is taken by gating (triggering) the DSO at a low level from DSO-BNC 1, and by setting the DSO to make a plot of maximums from the DSO-BNC 1 signal. After setting the DSO to gate on DSO-BNC 3 and record a plot of maximums from DSO-BNC 1, the upper level and lower level settings of window 114 of SCA1 are adjusted in an iterative process. Windows 114 and 116 are adjusted with upper level and lower level knobs (not shown) on the SCAs. Similarly gating on DSO-BNC 4, window 116 is adjusted. Window 114 is adjusted until the pulse amplitude plot shows only the characteristic gamma ray response ΔE. An example of a window width is shown at ΔE 64 FIG. 3. Window 116 may be set similarly narrow for a Δt experiment. Window 114 operates on shaped pulse 115, and window 116 operates on shaped pulse 117; these windows and pulses are only schematic of the operation inside the SCA circuits.

I call the histogram of times between pulses from each channel a Δt plot; it can be set up from the DSO parameter menu and uses the DSO smart gate (trigger) feature. A Δt plot obtains timing information from DSO-BNC 3 110 and DSO-BNC 4 112. The DSO smart gate is set up to gate on DSO-BNC 3 only after DSO-BNC 4 has sensed a pulse within tₛ μs of the pulse from DSO-BNC 3; this gate condition internally creates a coincidence timing pulse. tₛ is a window of time for valid coincidences. In preparation for the Δt plot, adjustments on delay controls on SCA1 and SCA2, and a gate delay adjustment on the DSO must be performed. The LT344 DSO histogram process 118 internally creates Δt plot 120 in response to the coincidence timing pulse. In experiments examining the spread in shaped pulse amplitudes from one shaping amplifier channel, usually channel 2 amplifier 94, that was gated from both channels in coincidence by the coincidence timing pulse, the LT344 DSO histogram process 122 internally creates a coincidence-gated pulse amplitude plot 124.

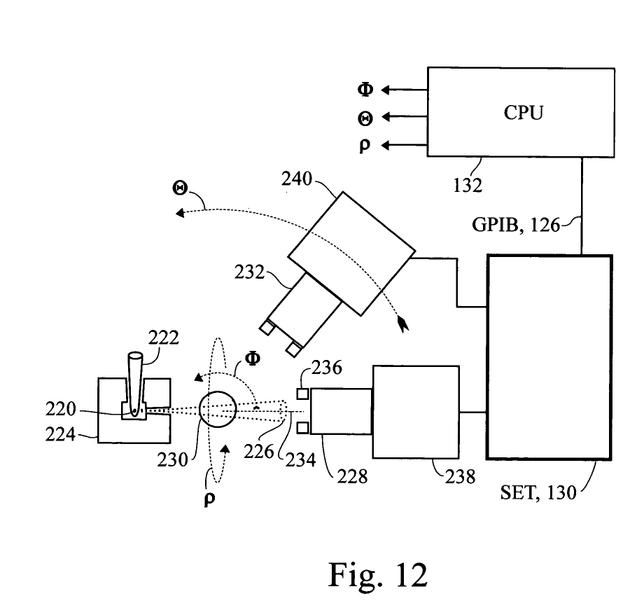

The system can be fully automated if counters 100, 102, and DSO 104 are equipped to communicate using the general purpose instrumentation bus GPIB 126 for data collection under computer CPU 128 control. The demarked set of electronics SET 130 is used to simplify the description of another preferred embodiment in FIG. 12.

Much of the above technique describing SET 130 for making Δt plots and coincidence-gated pulse amplitude plots are standard procedure for nuclear physicists and engineers. Physicists are not accustomed to the combination: examine a gamma spectrum, window a characteristic gamma peak, such as FIG. 3 ΔE 64, and search for pulses in coincidence from two detectors responding to radiation within this same window ΔE; that would violate the principle of the photon.

Experimental Results Using Tandem Geometry

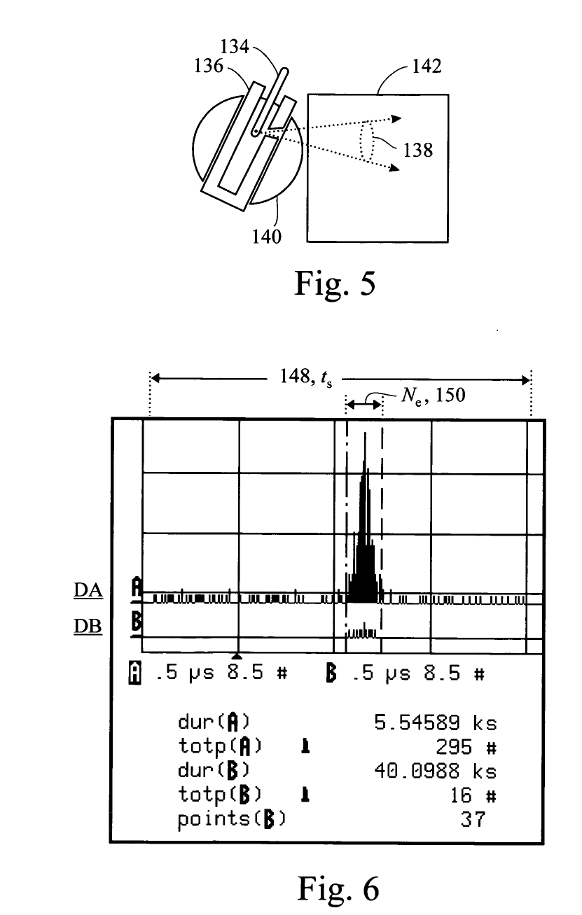

Many tests were performed with the same electronics as FIG. 4 but with different detectors and source collimator. The detectors and source holder of FIG. 5 were used for the experiment of FIG. 6; otherwise electronics and description for preferred embodiment of FIG. 4 apply. In FIG. 5 source holder 134 holds 5 μCi of Cd109 at its tip inside collimator 136 made of tin. Collimator 136 had a hole to let through cone 138 of gamma rays to interact with two NaI(Tl) scintillators. Scintillator 140 of channel 1 was a 42×42 mm cylindrical well-type with a 17 mm cylindrical hole through its side to accommodate collimator 136. Cone 138 passed through a short wedge of scintillator 140 ranging from 3 to 5 mm of NaI(Tl) scintillation material. Radiation of cone 138 continued to channel 2 scintillator 142, a 2×2 inch BICRON brand NaI(Tl) with an integral PMT (not shown). This well-type scintillator 140 was used because it is easier to obtain than the thin slab of FIG. 4. Gamma rays in cone 138 must pass through scintillator 140 to get to scintillator 142.

In the experiment for FIG. 6 performed Jul. 5, 2004, Δt plot DA using Cd109 gave good resolution. Plot DB was a Δt plot with source and holder 134 removed. For both plots the window of time 148 was set at tₛ=2 μs, as marked. FIG. 6 is a section of screen capture from the DSO with some annotation added. The screen capture includes data: dur(A) is the duration of plot DA, totp(A) is the total number of detection events in plot DA, and (B) is for plot DB. A section of bins Nₑ 150 were used to count the unquantum effect. In plot DA the effect in 150 stands above a random response seen on both sides of this section, I call the wings. In plot DB coincidences caused by background radiation show 16 events all within 37 bins in a duration of 40.1 ks; an average one count every 1.4 hours. This small background rate is most likely due to cosmic ray showers and will be subtracted from the rate read from section Nₑ in plot DA. After correcting for background, any rise in the average count in section Nₑ above the average number of random events in the surrounding wings of the Δt plot is evidence that chance is surpassed. It is valid to just use the tallest bin of plot DA for calculations, but I will use the much more conservative average just stated. The experimental coincidence rate Rₑ=(295/5.5K−16/40.1 ks)/37=0.00144/bin-sec. All my calculations in this disclosure use this more conservative Rₑ, with background subtracted as just shown.

A chance coincidence rate R_{c} (or simply a chance rate) can be calculated two ways: from the noise in the wings of the Δt plot, or from the singles counters. The singles counters on channel 1 gave R₁=291/s, and for channel 2 gave R₂=30/s, with both SCAs similarly windowed around 88 keV. The time constant is determined from the DSO as the time per bin at τ=5 ns. A different chance coincidence rate equation is used for Δt plots:
R_{c}=τR₁R₂, Eq. (13)
Equations (12) and (13) are standard in the nuclear measurement industry and are found in G F Knoll's Radiation Detection and Measurement. Using the singles counters, R_{c}=43.5×10⁻⁶/bin-sec. Using the wings of the Δt plot a crude but directly measured chance rate was obtained as a cross check at R_{cw}=51×10⁻⁶/bin-sec. Rₑ/R_{c}=33×chance. This rules out photons altogether.

It was important to monitor every pulse to assure myself that I was counting well behaved detector pulses. The LT344 DSO performed this task well in analog persist mode. I used this monitoring technique in all tests using the LT344 DSO. I maintain that less than 1% of all my data reported in this disclosure contain falsely shaped pulses. The experiments and preferred embodiments may be constructed without this feature but it is best to include some form of test, or use a pulse shape filter, for a convincing demonstration.

It was very important to show the unquantum effect was not a special property of emissions from Cd109. Another experiment (not shown) using Co57 using a lead collimator in the well tube on channel 1 gave 190 times chance. Lead has a fluorescence at 87 keV and care was taken to avoid windowing near this part of the spectrum. This is why I do not use lead for the collimator with Cd109. Many experiments were performed with Co57, some with tungsten lined collimators with similar results. Some experiments have employed an aluminum filter mounted at the aperture of the collimator (not shown) to reduce x-rays; no difference has been noticed from this practice.

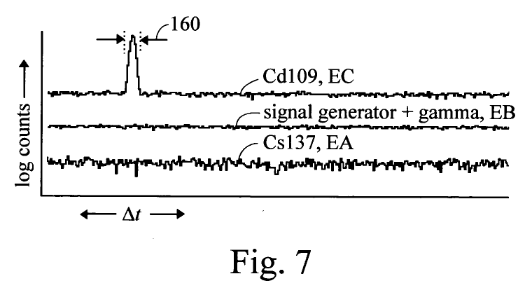

FIG. 7 shows Δt plot EA. using Cs137, a signal generator plot EB, and a long time. Δt plot EC using Cd109. These early experiments were performed August 2003 and used a time-to-analog converter fed to a multichannel analyzer. Plot EA was a search for an unquantum effect using a higher frequency gamma ray. Experiment of plot EA used: 1 μCi of Cs137 in lead collimator, channel 1 NaI(Tl) 1 inch dia. detector, channel 2 NaI(Tl) 2 inch dia. detector, both SCA windows on the 662 keV characteristic gamma ray region, collected for 10.5 hours. Plot EA showed only random times between events. This failure to read the unquantum effect is important to compare to a later success, whereby I have deciphered conditions necessary to reveal the effect. Plot EB is data from a control experiment using a signal generator on channel 1 in coincidence with a Cd109 source on channel 2, and also gave a random Δt plot. Plots EA and EB are what physicists usually see. These are important controls that I have performed to show that my device and technique delivers a chance coincidence rate that obeys Eq. (13).

Returning to the issue of energy conservation, there is a way to test that my effect upholds it. If there are events triggered by the gamma in coincidence, it should remove events from the random distribution in the wings of the Δt plot. This test was attempted in a 4.8 day long test shown in plot EC, using hardware of FIG. 5, and a time-to-analog converter. The effect section 160 accounted for 0.6 of all counts on plot EC, but the fraction in the unquantum effect was only ˜1/300 of the total true start counts. The measurement revealed a slight lowering of the count in the wings but this lowering did not surpass the quantity in my error analysis. The experiment is worth mentioning because it should be repeated with refinements employed to verify energy conservation.

Though my early tests with Cs137 revealed no unquantum effect, I have on Aug. 18, 2004 discovered how to reveal it using the specially made thin detector, as shown in data of FIG. 8. The hardware for data of FIG. 8 was the same as that of the preferred embodiment of FIG. 4 with these specifications: on channel 1 a 40 mm square by 4 mm NaI(Tl) thin scintillator, on channel 2 a 42×42 mm NaI(Tl) scintillator, a collimator made of a 2 inch thick lead block with a ½ inch diameter hole to accommodate a standard 1 μCi test source of Cs137. These were the same source and collimator used for test EA of FIG. 7. The collimator remained fixed and the source was retracted within the collimator to different distances from the channel 1 detector. In plots of FIG. 8 the duration of experiments and vertical scalings are different, but they are still valuable for seeing how the unquantum effect appears above randomness. Horizontal time scale is 500 ns for the full width shown in each plot. Plot FA shows background coincidences with no gamma source at a total of 260×10⁻⁶/(window-sec) in a 10 bin section 166. Terms window and section are similar; window is for the SCA setting, and section is for the same setting seen on plots or spectra. I use the term spectrum for an ungated plot. For plot FB the source was 1 inch from the detector, and shows only randomness, as expected by quantum mechanics. For plot FC the source was at 2 inches with the same result. For plot FD the source was at 3 inches, and an unquantum effect begins to appear: within section 166 Rₑ measured at only 1% above chance, calculated by singles counters, and after subtracting background. For plot FE at 3.5 inches, duration 84.4 ks, the unquantum effect ratio calculates to 1.6 times chance. Since Cs137 decays by a beta decay process, this shows the unquantum effect is not limited to an electron capture process. The small unquantum effect read from Cs137 is consistent with the theory of linking the effect to detector photoelectric effect efficiency. In plot FF the same Cs137 source was in the same block of lead but the block was rotated 90 degrees and extra lead was added so the gamma rays needed to pass through 1 inch of lead in a straight path to the 4 mm thick NaI(Tl) detector. Comparing the distance to the lead effects: At 3.5 inches,
R₁=12.4/s, Rₑ=20×10⁻⁶/bin-sec, R_{c}=12.4×10⁻⁶/bin-sec, Rₑ/R_{c}=1.61.
   Through 1 inch of lead,
R₁=21.7/s, Rₑ=26×10⁻⁶/bin-sec, R_{c}=15.4×10⁻⁶/bin-sec, Rₑ/R_{c}=1.68.
   This important test shows that the unquantum effect can be manipulated to appear by two different methods. I did not control closely to maintain similar singles count rates with distance, but this was done in the next test.

FIG. 9 shows data taken July 2004 using: the same detectors used for FIG. 8, the electronics of FIG. 4, and a 1 μCi Co57 source collimated with a 1/8 inch diameter ¼ inch thick lead aperture. The source and collimator moved as a unit as prescribed in FIG. 4. Horizontal time scale is 1 μs/division, and the DSO smart gate time window was tₛ=2 μs as shown. Plot GA shows background at 421×10⁻⁶/sec in a 26 bin effect section and was used to subtract its rate from data of the remaining plots. Plot GB had the source to detector distance at ½ inch and revealed 22.5×chance. Plot GC at 1 inch revealed 9.3×chance. Plot GD collecting data for 34 hours at 1.5 inches revealed 11.6×chance. Here at 122 keV from Co57 the unquantum effect was generally stronger with the source close to the detectors.

With 122 keV when the source was moved back, the unquantum effect was lower, even though the singles rates were substantially unchanged. With 662 keV when the source was moved back the unquantum effect was enhanced. At 662 keV, the Pb test suggests the gamma ray wavepacket is made to spread-out, similar to moving back the source, for each individual hv wavepacket as it scatters through the lead. The whole of these tests indicate a solid angle to each hv emission that is narrower with frequency and that there is a size to match between each microscopic hv cone and the microscopic absorber to optimize the unquantum effect. This size match allows some of the needle radiation to pass and some to be absorbed to gamma-trigger more than one detection. In the tests of FIGS. 8 and 9 the macroscopic cone of radiation incident on the detector did not miss either detector, so the ratio of flux between the two detectors remained a constant. However, with Cs137 the flux rate was lowered with distance and may have played a role in comparing these two experiments. The preferred embodiment specifies moving the source and collimator as a unit to aid these investigations. Only the characteristic spectral sections (the photopeak) were windowed and not the Compton sections.

Tests in August 2004 (not shown) with the 59 keV of Am241 did not reveal any unquantum effect. These are important to describe to show limitations of reading the unquantum effect. For the channel 1 detector, tests using the 4 mm NaI(Tl) scintillator and a 3/4 inch thick CsFl(Eu) scintillator were tried. Gamma flux passed through the channel 1 detector to a 2 inch NaI(Tl) on channel 2 in tandem geometry. CsFl(Eu) was chosen because of its greater transparency at this lower gamma frequency. NaI(Tl) was also tested at the channel 1 detector. Am241 emits a gamma ray by alpha decay, and I conclude this influences the classical properties of the emitted gamma ray to cause a null unquantum effect. These measurements offer clues to the classical structure of an individual hv pulse, and have only been explored very recently using the method of this disclosure. The decay process of both Cd109 and Co57 are by electron capture, and evidence shows this mechanism is the best way to create the classical spatial and temporal pulse-like attributes necessary for the unquantum effect to be detected. The common factors among these experiments indicate that a high pulse amplitude resolution at the detector, a high photoelectric effect efficiency at the detector and an electron capture process at the emitter work best. These methods of reading spatial and temporal properties of an hv of a gamma ray are not understood with the photon model.

So far Cd109 and Co57 are the only sources that have revealed a strong enough unquantum effect to be useful as a probe of a material scatterer, but the search for such sources has not been exhaustive. The Am241 gamma from alpha decay is expected to be more pulse-like and have a narrower solid angle than an hv of radiation emitted from an x-ray source, so it is unlikely that an x-ray source would display the unquantum effect, but it remains to be tested. The failure of the photon model for gamma rays implies the entire electromagnetic spectrum is purely classical. Use of other radiation sources or detectors not described in this disclosure, that display the unquantum effect would depend on the method and underlying physics in this disclosure.

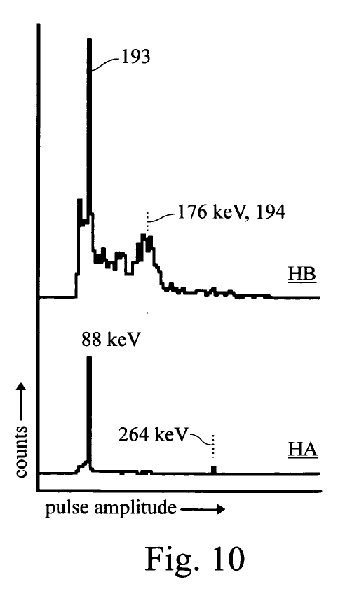

Data for FIG. 10 is from a test of May 2003 using the NaI(Tl) well-type detector at channel 1 in tandem with an HPGe detector at channel 2. My 5 μCi of Cd109 was inside the well with a copper collimator insert. The channel 2 SCA window was widened to observe a higher spectral section of what passed through in coincidence. Detector orientation was the same as shown in FIG. 5. Plot HA is a singles spectrum from the HPGe, and was useful for calibration because the 264 keV peak from Cd113m was present. Plot HB is a coincidence-gated pulse amplitude plot where the triggering was accomplished with one-shot pulse generators feeding an ORTEC 414A coincidence module set to overlap 100 ns pulses. The 414A gated a multichannel analyzer that recorded pulses from the channel 2 shaping amplifier via an analog delay line. The final timing adjustment to overlap two 100 ns pulses was aided by a test with Na22. I took special care to eliminate distorted pulses from the channel 2 detector by building a high speed pile-up rejector of my own design using a shape mask on a CRT. Coincidence-gated pulses of non-standard shape were filtered from entering data to plot HB. Pile-up elimination was always less than 1% of the recorded coincidences. It was later determined that this low rate of false pulses would not significantly affect the gated pulse amplitude plot and resulting statistics so the pile-up rejector was only used for this experiment. The LT344 DSO monitored all pulses and it was found that this was a good way to read any form of distortion, even forms that a good pile-up rejector would miss. Plot HB reveals an impressive coincidence-gated peak 193 only one bin wide at 88 keV with 0.0056 counts/s. With R₁=1289/s, Eq. (13) gives R_{c}=1/(1293 seconds). Therefore chance is exceeded by Rₑ/R_{c}=7.2. At 2×88 keV the gated plot HB clearly shows a feature not present at all in the singles spectrum HA, peak 194 at 176 keV. The 176 keV peak is predictable from my single detector sum-peak analysis of section 60 FIG. 3. In an earlier experiment of July 2002, I first observed coincidence-gated unquantum effect plots in a similar manner using Cd109 and two NaI(Tl). If by some strange way the Cd113m 264 keV gamma were to generate a pair of events in coincidence by Compton scatterings, a broad spectrum of pulse amplitudes would be present at the 88 keV point 193 in plot HB. The incredible gated single bin peak 193 of plot HB shows this is not the case. This eliminates any argument against a contaminant causing the unquantum effect.

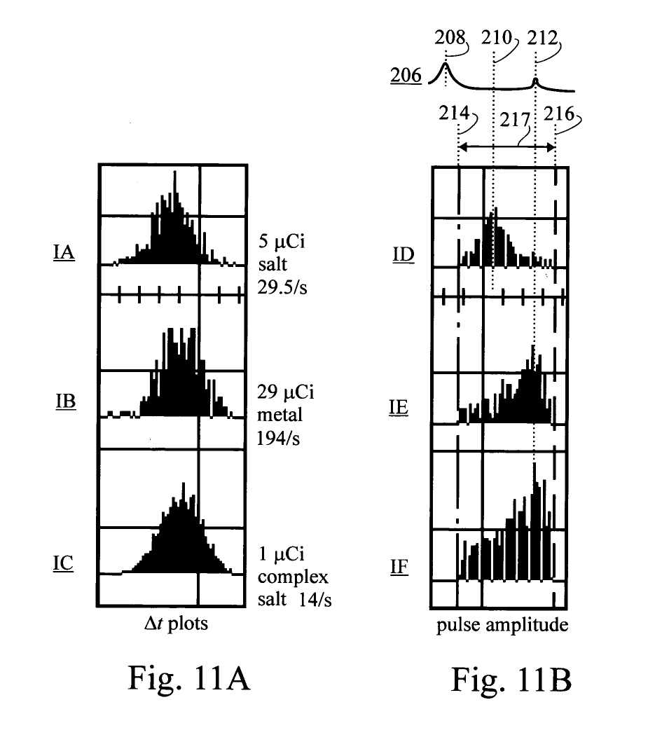

Continuing with the tandem geometry are results of tests begun Jul. 11, 2004, shown in FIGS. 11A and 11B. Orientation of components are the same as for FIG. 5, and the electronics are the same as for FIG. 4. The NaI(Tl) well-type scintillator was on channel 1 in tandem with the 2 inch NaI(Tl) on channel 2. Here the LT344 DSO was used to simultaneously generate both the Δt and coincidence-gated pulse amplitude plots. To obtain good pulse amplitude data, time window tₛ was narrowed to 300 ns to exclude most of the random response (the wings); full horizontal scale shown for FIG. 11A is 350 ns. FIG. 11A are Δt plots using three preparations of Cd109 for sources.

Plots IA used the same 5 μCi preparation of Cd109 as used in other experiments here of this specification. This source was prepared in a glass tube melted and drawn to a sharp depression. Ten μCi ¹⁰⁹CdCl2 solution in water was dropped in and evaporated to leave a salt deposit of small physical dimension. This being about a year old and encased in glass made it ˜5 μCi.

In plot IB the Cd109 was specially prepared by electroplating a ¹⁰⁹CdCl2 solution onto a thin platinum wire, depositing approximately 29 μCi of metallic Cd109. In plot IC the Cd109 was specially prepared by evaporating a ¹⁰⁹CdCl2 solution, but this solution also had sulfuric acid and NaOh added. These chemicals were from what was left over in the electroplating solution, but proved even more useful in making a potent Cd109 salt source. The solution was evaporated in a centrifuge tube to deposit a salt with about 1 μCi. It took much work in January to June 2004 to optimize these electroplating and salt depositing processes. A servo loop monitored current in the plating process to perfectly control a motor to position the platinum wire, just breaking the solution surface.

The rates from the well-type scintillator for channel 1, windowed around the 88 keV gamma response are posted to the right of FIG. 11A, and give evidence of the lower μCi of the complex salt. The degree above chance for each experiment was calculated as usual: {[(coincidence count in Δt window)/(experiment time)]−(background coincidence rate in same window of time and energy)}/(bins of Δt window)=(coincidences due to isotope)/(bin-sec)=Rₑ. For plot IA 5 μCi in salt form gave Rₑ/R_{c}=70, plot IB 29 μCi metal form gave Rₑ/R_{c}=94, plot IC 1 μCi complex salt Rₑ/R_{c}=3853.

FIG. 11B are pulse amplitude plots using the same sources as in FIG. 11A: the 5 μCi salt ID, 29 μCi metal IE, and 1 μCi complex salt IF. A reference spectrum of Cd109 was acquired for this test, but is only drawn 206. Point 208 marks 1×88 keV, 210 marks 2×88 keV, and 212 marks where 3×88 keV events would be detected. Plots of FIG. 11B are aligned to the same horizontal scale. SCA2 set lower level 214 and upper level 216 for these plots, defining SCA2 window 217.

Plot ID shows a trend of two pulses that overlapped in coincidence at mark 210 indicating two events in the channel 2 detector plus one in the well detector, all in coincidence. Plot IE shows a coincidence peak at mark 212 indicating that three events must have piled up more often than two events and that this happened in addition to the gamma-triggered event in the channel 1 detector; adding to 4 events in coincidence. A similar analysis holds for plot IF.

Comparing plots ID and IF shows that perhaps less, but not more μCi, can bring out the 3×88 effect. Comparing plots ID and IE shows that a change to the metallic state and more μCi can bring out the 3×88 effect. Comparing plots IB and IC, we see that the complex salt was extremely potent in producing coincidences surpassing chance. This is my best: 3853 times better than chance. An enhanced unquantum effect with salt compared to the metallic form of Cd109 was confirmed in several other tests, including those windowed just at the characteristic gamma.

Conventional gamma spectra were taken, and a careful comparison between the metallic Cd109 used for plot IB and the complex salt Cd109 used for plot IC showed no difference other than overall activity. These tests also confirm that the Cd113m used in plots of experiment IA, ID, and in previous experiments, does not play a role in causing coincidences at 264 keV (3×88) spectral position. Plot ID had a 2×88 response instead of a 3×88 response.

My success in electroplating Cd109 led to the discovery that the metallic Cd109 in most experimental arrangements revealed lower unquantum effect potency compared to the same experiment with a salt Cd109. This leads to a new way to use the unquantum effect. Mixtures and crystalline state of matter at the source affect the classical emission properties of the gamma ray. There was pre-existing evidence of a related effect published in “Comparison of the values of the disintegration constant of Be⁷ in Be, BeO and BeF₂” Physical Review 90 (1953) pg. 610 by J J Kraushaar et al, where the decay rate of a beryllium isotope in an electron capture process can be modified by its chemical state. Their effect was very small and difficult to observe. My discovery also links a chemical state to the electron capture process, but my method reads it much easier.

Preffered Embodiment Using Beam Splitter Geometry

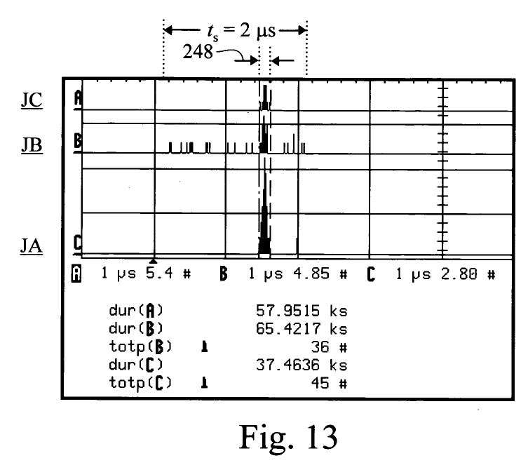

FIG. 12 is an arrangement for testing the unquantum effect in a beam splitter geometry. Typically, a Cd109 source is used. Source 220 resides in holder 222, collimator 224 directs a beam of gamma rays in cone 226 toward channel 1 NaI(Tl) scintillator 228. A cone shape is not necessary. The primary purpose of using a collimator in beam splitter geometry is to shade the channel 2 detector 232 so that it only receives gamma rays scattered from scatterer 230, a material under study. Detector 232 must not receive radiation of any consequential amplitude directly from source 220. Another reason for collimating the beam is to reduce radiation from scattering within a surrounding shield (not shown), which would obscure experimental interpretation. The shield should be a box lined with at least 2 mm of sheet tin. This thin Sn was tested to be adequate for some experiments, but the experiments reported in this disclosure were all done in my Pb shield lined with Sn and Cu. Scatterer 230 is placed in cone 226 as close to source 220 as possible. An object of this FIG. 12 embodiment is to measure variation of the unquantum effect with angles Φ, Θ, ρ to determine properties of the scatterer. There are many other ways to use this generalized instrumental geometry, some examples of which are in my experimental results. This embodiment has been constructed and has delivered data in my laboratory, but has not yet articulated axis ρ. In tests, an example of which is described in FIG. 13, good working values were found: source 220 at 29 μCi of Cd109 refined by electroplating onto a ˜0.001 inch platinum wire (not shown), cone 226 with 20 degree spread, collimator 224 made of a 3 cm cube of copper with a tin aperture (not shown) molded and machined to define cone 226, and source 220 to scintillator 228 distance set to 8 cm. These values are not critical, but attempts to optimize an experiment will influence the specifications interdependently. The minimum angle of cone 226, depends upon the distance to scintillator 228, the strength of source 220 and the duration of the experiment. Source 220 is best prepared to be as physically small as possible to work with collimator 224 to maximize the radiation flux in cone 226. The small source has a great advantage in the ability to create a narrow radiation cone with even weaker sources to remain exempt from stricter license requirements. Scatterer 230 typically a sphere 1 to 3 cm in diameter, is a sample of material under study placed to intersect cone 226, and placed as close to source 220 as possible; it was found advantageous to keep within 2 cm. A sphere will not introduce an attenuation artifact due to material thickness when changing orientation. If ρ is not articulated a cylinder works well. A flat plate can work well with the understanding that an angle adjustment will vary gamma ray transmission. Defining a plane the figure is drawn in, and recognizing axis 234 through the center of cone 226, Θ is the angle for rotatating scintillator 232 in the plane from axis 234, Φ is the angle of rotating scatterer 230 in the plane from axis 234, and ρ is the angle for rotatating scatterer 230 on axis 234.

In future laboratory implementations experimental run times can be shortened by using a stronger radioisotope source, or miniaturizing the entire apparatus. Closely related is the desire to narrow cone 226 to achieve high resolution data matrixes of the unquantum effect for different angles Φ, Θ, ρ.

To aid in defining narrower ranges of angles, aperture blocks 236 (one of 4 labeled) of an appropriate gamma blocking material may be placed to narrow the exposed area of scintillators 228 and 232. Scintillators 228, 232 are coupled to photomultiplier tubes 238, 240 in the usual manner to create gamma detectors. HPGe or CZT detectors will also work well in this embodiment. Signals from photomultiplier tubes 238, 240 are wired to electronics SET 130 of the same use and description outlined for FIG. 4. SET 130 interfaces by GPIB 126 to CPU 132. CPU 132 interfaces to motion controls (not shown) to control angles Φ, ρ for orienting scatterer 230, and Θ, for the positioning scintillator 232. A stepper motor system initialized with limit switches is adequate, and one degree or better resolution is recommended. An experiment will be a matrix of coincidence data, of either Δt profiles, or coincidence-gated pulse amplitude profiles from SCA2 window. Between each experiment, in a sequence, any of the angles Φ, Θ, ρ would be incremented, all under computer 132 control. With strong gamma sources, collecting profiles of coincidence data may become practical while slowly rotating an axis.

Experimental Results Using Beam Splitter Geometry

I have performed scattering tests with different sources, scatterers, geometries, detectors, applied fields, angles, and temperature, all defying the principle of the photon. FIG. 13 shows data from May 11, 2004. The arrangement of components is similar to FIG. 12. Source was the 29 μCi Cd109 electroplated platinum wire mounted inside a copper block with a tin conical aperture to define cone 226 of FIG. 12, that I tested was radiating about 20 degrees wide. At the aperture of the collimator was a filter of 2 mm aluminum to attenuate Kα x-rays. The channel 1 detector was a 1.5 inch diameter BICRON NaI(Tl) 8 cm from the scatterer and positioned to optimize capture of gamma rays directly from the source. The channel 2 detector was a 3 inch diameter BICRON NaI(Tl) placed 8 cm from the scatterer, with Θ=60 degrees. Both SCAs were set to window the characteristic 88 keV gamma section. The scatterer was 21 silicon wafers 4 cm diameter in a stack 6 mm thick. These were clean wafers of the type used in semiconductor manufacture, with an orienting flat I placed toward the channel 2 detector. The scatterer was mounted to pivot on axis Φ.

FIG. 13 is a section of an LT344 DSO screen capture with annotation around it. In section 248 are bins used for calculating Nₑ=26 bins, and the time window tₛ=2 μs, as marked. In FIG. 13 Δt plot JA of coincidences was accumulated over 65 ks with the scatterer mounted for incident gamma rays 60° from its surface normal and with Θ=60° as if to reflect like a mirror to the channel 2 detector; R₁=27/s, R₂=9.5/s, Rₑ/R_{c}=5.8. Δt plot JB of coincidences was accumulated over 37.5 ks with the scatterer mounted with its plane perpendicular to the incident gamma rays: Θ=0°, R₁=6/s, R₂=4/s, RₑR_{c}=254. Δt plot JC of coincidences was accumulated over 58 ks from background only. The only difference between plots JA and JB is from rotating the scatterer, and from this Rₑ/R^{c} had increased a multiple of 254/5.8=43.8. Notice that even with less material in the way the singles rate R₁=6/s for plot JB lowered, indicating radiation was diverted. Also, the effect was not enhanced by the wafers acting like mirrors, indicating a volume effect. The orientation of the atoms must be at play. In silicon the spacing between atoms is d=0.313 nm, but the wavelength of 88 keV gamma is λ₈₈=c/v=hc/hv=(4.41×10⁻¹⁵ ev-s)(3×10⁸)/(88 keV)=0.015 nm. To deflect Θ=60°, the perpendicular of an internal Bragg plane to the incident ray would also be 60°. Solving the Bragg equation, nλ=2d sin θ for the integral number of wavelengths gets n=36. Inserting the next n at n=35 in the Bragg equation gets θ=57°, a difference of 3°. However the solid angle of the cone of incident radiation was much wider at ˜20°, and also a large channel 2 detector was used, so any accidental Bragg resonance would have completely blurred out. This is not a Bragg reflection between atomic planes, but instead a Bragg reflection between planes at spacing close to the gamma ray wavelength: planes of electric charge-wave envelopes, a concept elaborated on in my THEORETICAL BACKGROUND.

Recall the test using the metallic Cd109 of FIG. 12. It worked well when the angle was adjusted. So far, this is the only situation where I found the metallic source worked better than the salt source. For coincidences to be gamma-triggered more frequently after the gamma pulse interacted with the silicon microstructure, the gamma must have had its classical wave structure modified differently with the two scatterer angles Φ. Future experiments as a function of distance with the same apparatus can determine if a focusing effect was at play. This is the true beauty of my method. It is a method guiding the design of experiments in violation of the principle of energy quantization that leads to fundamental discoveries.

The next three experiments with data in FIGS. 15, 16, and 18 all use two HPGe detectors for coincidence-gated pulse amplitude experiments performed October 2003. The same preamplifiers, shaping amplifiers, SCAs, and LT344 DSO were used, however in these tests a separate coincidence module set to 400 ns was used to gate the DSO. The DSO was used to obtain coincidence-gated pulse amplitude plots from SCA2, and monitor each coincidence-gated pulse shape to insure that pile-up and ringing were not present. The channel 2 detector received gamma rays deflected by a scattering material. Pulse amplitude data is gated when an undeflected ray caused a channel 1 detection event in coincidence with the deflected channel 2 detection event. The 5 μCi source of Cd109 was encased in a copper collimator that released a 40 degree cone. The enhanced resolution provided by these detectors assures that the poorer spectral response in other tests using NaI(Tl) detectors is in no way responsible for creating false coincidences. A typical window of frequencies used in the channel 1 detector is marked ΔE, 32 in FIG. 2. By windowing SCA2 to include the lower frequency Compton events, these tests can measure both Compton and Rayleigh scattered gamma rays in coincidence with the undeflected ray. Rayleigh scattering, often called coherent scattering, is a change in direction with no wavelength increase and no Doppler charge-wave recoil. The Compton window cannot be made too wide or it will void the unquantum effect. With too wide a window on SCA2 a gamma can split at the scatterer, obey E=hv and put one fraction of its frequency in the transmitted ray and the remaining fraction of its frequency in the deflected ray thereby satisfying the principle of the photon to cause coincidences. The principles of this invention are to specifically avoid that scenario. The spread of pulse amplitudes from the detector needs to be taken into account, and this is a good reason for performing this kind of test with two HPGe detectors. Define E_{H1}={pulse amplitude in channel 1 at the high level of SCA1}, similarly E_{L1} for the low level, and for SCA2 write E_{L2}. In every experiment the criteria must be met that E_{L2}+E_{L1}<E_{H1}, otherwise the frequency could be lowered in a fluorescence process to cause true coincidences not in violation of the photon concept. The measurement can still be accomplished with NaI(Tl) detectors with care. Another required step in these tests is to see that the coincidence-gated rates break chance when calculating the singles rates with this widened window, and this was monitored for as well.

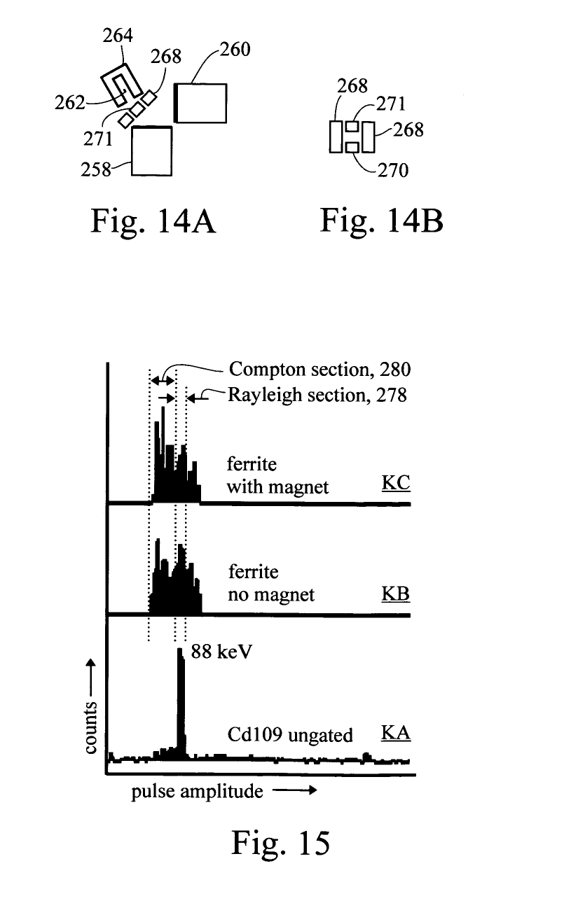

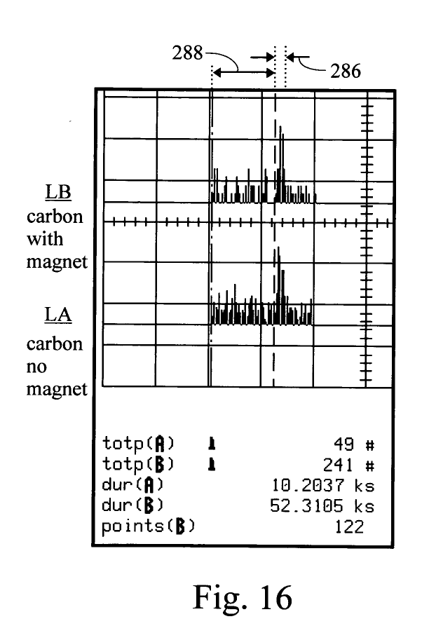

A comparison of magnetic effects using a ferromagnetic and a paramagnetic material scatterer was performed using coincidence-gated pulse amplitude tests. Components are shown in FIG. 14A: channel 1 HPGe 258, channel 2 HPGe 260, 5 μCi Cd109 source 262, collimator 264, magnetic conductive bars 268, neodymium magnet 270, 1.5 cm cube scatterer 271. FIG. 14B shows the magnet assembly as seen from source 262. It was designed so that the magnets could be removed for a valid control experiment. Hardware of FIGS. 14A and 14B were used for the data of FIGS. 15 and 16. For data of FIG. 15, scatterer 271 of FIG. 14A was a cube of ferrite. FIG. 15 plots are an ungated spectrum KA for reference, gated plot KB without magnet, gated plot KC with magnet. Used in calculation are a 12 bin Rayleigh section 278, and a 256 bin Compton section 280. Calculating counts per bin-second, the Rayleigh/Compton=P ratio of rates from non-magnetized plot KB was 1.08, and from the magnetized plot KC was 0.76, giving P_{magnet}/P_{nomagnet}=0.70. This is a 42% shift toward the Rayleigh section with no magnet. With no magnet, Compton scattering is comparable with Rayleigh indicating unbound charge in this substance. With the magnet there were more scattering sites shifted to the free charge-wave; just what we would expect for a ferromagnetic material.

For data of FIG. 16, scatterer 271 of FIG. 14A was a cube of carbon. This carbon was tested to be free of iron impurities. Plots are coincidence-gated pulse amplitude LA with no magnet, and LB with magnet. Calculations use Rayleigh section 286, and Compton section 288. The duration time (dur) of the experiment and the counts for the Compton shifted section are marked and listed (totp) by the screen capture that included LT344 DSO parameter numerics. I conservatively took Rayleigh section 286 at 6 bins wide, measured ratios Rayleigh/Compton=P, and took the ratio for both cases to get P_{magnet}/P_{nomagnet}=1.4. With the diamagnetic carbon there was a 40% enhancement of Rayleigh scattering with the magnet. With the magnet, the Compton downshifted section was suppressed.

The effect of a magnetic field on gamma scattering was attempted by AH Compton in “The nature of the ultimate magnetic particle” Science Vol. XLVI, no. 1191, pg. 415, Oct. 26, 1917. His failure to see evidence for his ring electron model was part of what led him and modern physics to abandon the ring electron in favor of the point electron. Compton's 1917 work was similar to mine of FIGS. 15, 16, but with x-rays and no coincidences. My positive magnetic influence is consistent with Compton's original ring electron model.

With the ferrite, a ferromagnetic substance, the magnetic field enhanced Rayleigh scattering; with carbon, a diamagnetic substance, the magnetic field reduced Rayleigh scattering. Relating the degree of recoil motion of the charge-wave to these magnetic properties offers a new kind of material science probe with the ability to sort out stiff and flexible bond structures. The magnetic field used in these tests was of the order of 0.1 T. From a cyclotron resonance calculation I had performed using pair creation, I was able to calculate for the proton that its magnetic field is about 8×10⁶ T at a radius of 1×10⁻¹⁴ m. Then using a 1/r³ calculation, 0.1 T would be the strength at about 0.2 Bohr radius. Using calculations of this sort one can determine the radius of the scattering site as a function of magnetic field strength. Tests like those for FIGS. 15 and 16 can be performed over a range of field strengths, and angles, to reveal the shape and nature of atomic bonds.

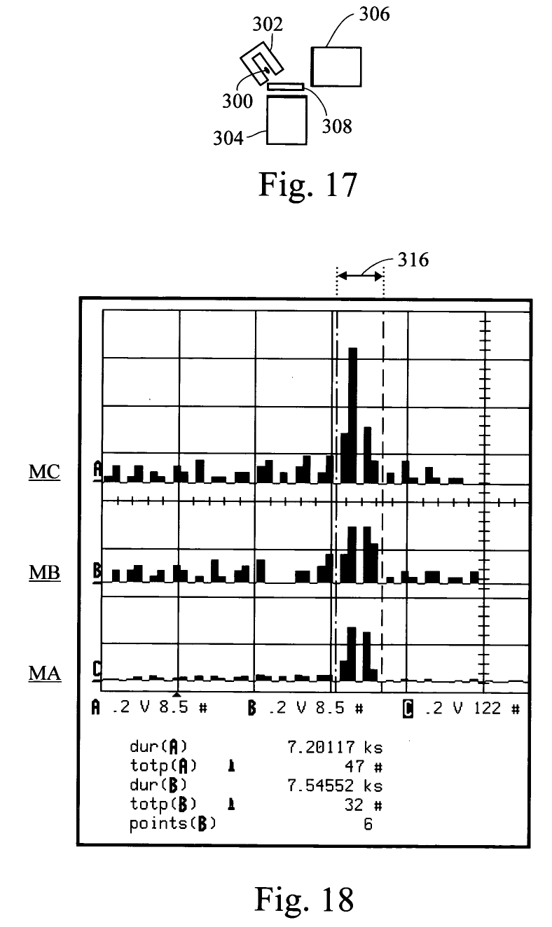

FIGS. 17 and 18 refer to an experiment on how temperature changes the shape of a coincidence-gated pulse amplitude plot using 88 keV gamma rays. FIG. 17 shows the 5 μCi Cd109 source 300, in copper collimator 302, directing gamma rays to channel 1 HPGe detector 304. Channel 2 HPGe detector 306 recieves scattered gamma from scatterer 308. Scatterer 308 was a 2 inch×6 inch×3/8 inch thick slab of aluminum. The lower 3 inches of the Al slab was in a styrofoam chamber for liquid nitrogen (LN). The upper 3 inches of the slab was in the gamma ray path, insulated by 1/4 inch of Styrofoam, and wrapped to prevent ice formation. The apparatus was designed so no component needed to be moved to pour LN. The cold test ran ˜1.3 hours, and the room temperature test ran ˜1.1 hours. A temperature sensor was also employed. FIG. 18 is a section of screen capture from the LT344 DSO with surrounding annotation, and shows plot MA of a Cd109 singles spectrum for reference, plot MB coincidence-gated pulse amplitude plot with the Al at room temperature, plot MC coincidence-gated pulse amplitude plot with the Al cooled by LN, and section 316 of 6 bins used in the calculation. A remarkable effect is readily seen upon comparing peak sections of plots MB, MC. At half-maximum amplitude, the peak section narrowed a factor of ⅓ when cooled. There were no other physical or instrumentation variables to account for this. External cold does not affect the detectors because they are already cooled internally by LN. In the very conservatively chosen peak section 316, the ratio of rates were R_{cold}/R_{warm}=(0.0065/s)/(0.0042/s)=1.54. From measuring and comparing warm and cold singles rates in this same peak section 316 (a warm one shown MA) the cold/hot ratio of singles rates was 1.07, and the cold/hot ratio of singles peak/Compton ratios was 1.03. Therefore, my method detects a gamma scattering property as a function of temperature that is not at all expressed in a conventional gamma ray singles spectrum. This experiment was repeated with similar results. An enhanced and spectrally narrowed Rayleigh scattering interaction is expected at lower temperatures due to less motion of the internal scattering centers.

Towards determining the nature of the scattering site, the unquantum gamma ray splitting technique shows that magnetism and temperature easily affect it, and the method of this disclosure provides a unique sensitive probe to study short wavelength matter-wave fields under various applied physical conditions. It is a way to study bond structures.

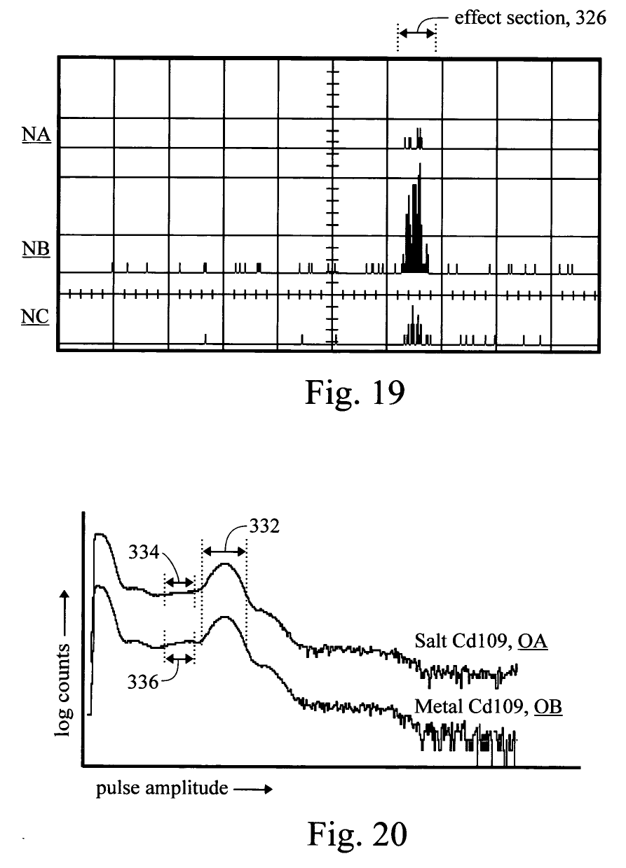

FIG. 19 from experiment performed May 2004, is to compare the response of two different preparations of Cd109 sources in a scattering geometry. The source was in a copper collimator, with a 2 mm aluminum filter to block x-rays, that directed gamma rays on a 0.3 inch thick 2.2 inch diameter semiconductor grade germanium disk scatterer taped onto the face of a 2 inch NaI(Tl) detector on channel 1. A second similar detector on channel 2 was placed away from direct rays from the source so that it received gamma that must scatter from the germanium. The geometry of these components was similar to that shown in FIG. 17. The source to scatter distance was 2 inches in the two tests described. The circuitry and the method of using the LT344 DSO was the same as described for FIG. 4. In FIG. 19, coincidence Δt plot NA of background gave 0.6 coincidences/ks in duration 15 ks. Coincidence Δt plot NB used a 30 μCi salt form of Cd109 and gave: R₁=24/s on channel 1; in the marked 22 bin effect section 326, corrected for background, Rₑ=34.5×10⁻⁶/s; R_{c}=874×10⁻⁹/s; Rₑ/R_{c}=36; duration of experiment 76.7 ks.

Coincidence Δt plot NC using the metallic 29 μCi Cd109 gave R₁=23/sec, similar to the salt test. In section 326 the uncorrected rate in duration 32 ks was 0.71/(22 bin-ks), can be statistically attributed to background, but using the numbers Rₑ=0.76/ks, Rₑ/R_{c}=7. The 5 fold greater unquantum effect of plot NB is attributed to the salt state of matter of the Cd109.

FIG. 20 shows logarithmic singles spectra using an NaI(Tl) detector, of the same salt Cd190 OA, and metal Cd109 OB sources used for FIG. 19. Window 332 represents how SCA1 and SCA2 were set for the tests of FIG. 19. In FIG. 20, on close comparison, the Compton section of the metal source spectrum 336 shows a small increase over the same section 334 of the salt source spectrum. This may be due to the platinum wire the metal Cd109 source is plated upon. The difference being about 20% cannot account for the much more dramatic change in the unquantum effect. The crystalline state of the source changed a classical wave-property of the gamma ray in a way that is not detectable with normal gamma ray spectroscopy.

Untested Obvious Applications

A sophisticated unquantum integrated circuit embodiment may be contemplated. To decrease experiment time, an array of CZT detectors gated in coincidence from a central element of the array would avoid multiple positioning of a single channel 2 detector, such as 232 of FIG. 12. Diffraction crystallography algorithms may be employed to process the information to create images of atomic bonds. Such a diffractogram will have the advantage of creating images of flexible and stiff components of charge-wave microstructure using the window technique used for FIG. 15. Many modes of operation await future refinement. It is in these future refinements and experiments that the method of this invention has its most important utility.

Removal of Artifact

No doubt skeptics will say there must be some artifact at play. In search of artifact I have performed hundreds of tests: different geometries, experimental strategies, different detector types and sizes, different electronic components and arrangements, different isotopes, shielded background, tested effect of background, filtered cosmic ray pulses, tested for misshaped pulses, tested for pulse amplitude drift over time, tested for satellite PMT pulses, tested effects of a higher frequency contamination (Cd113m) present, eliminated lead fluorescence, tested with different shield and aperture metals at the source. I monitor every pulse counted in coincidence for uniform shape, and subtract background. Most importantly I have understood how to modulate the unquantum effect with conditions of the scatterer, source chemistry, and source distance while holding everything else constant. Also, in tests with noise and wide SCA settings I found that lowering noise and narrowing the SCA window each improved the unquantum effect. Noise is not the source of my data.

Physicists have often challenged me with the idea that I have discovered something different from what I say it is; most often they think I discovered a new form of stimulated emission from the source that would shoot multiple simultaneously directed photons. The experiments above clearly do not fit this model, but I will address this issue directly. A simple calculation in Mossbauer theory shows the elements I have used at room temperature cannot undergo stimulated emission, but an experimental way to eliminate this possible cause is more convincing. In FIG. 10 there is a peak in plot HB at position 194, I call the 2× peak, that requires three detections in coincidence: two events make that peak, plus one in the channel 1 detector. That peak 194 had 0.0013/s in just one bin. There is more than one bin at this 2× position. The spread is due to some lowered by Compton down shifting and some raised by summing with the coincident Cd109 x-ray. Let's conservatively take 5 bins to get 5×0.0013=0.0065/s detected in triple coincidence. In the ungated spectrum HA of data taken with the channel 2 HPGe detector in the same experimental arrangement, the rate in the single 88 keV bin was R₂=3/s. These detectors only have about 10% efficiency. So to calculate what was emitted, when we detect two at a time in the channel 2 detector we need to account for this efficiency two times. The detector is only able to detect two at a time with 1/100 efficiency of what was emitted. (3 per sec)/100=0.03/s would need to be emitted three at a time aimed toward the channel 2 detector. That makes the ratio (detected/predicted)=0.0065/0.03. This means one in every 4.6 emissions would be emitted in triplicate in the same direction; in triplicate because it was also detected with the channel 1 detector. The efficiency of the channel 1 detector was not accounted for, making this 1/4.6 a very conservatively calculated large fraction. So nearly every photon aimed at the detector would need to be emitted in a triple coincidence conspiracy to make what we see in FIG. 10, eliminating the stimulated photon objection. Experiments by others showing it is extremely difficult to trigger gamma emission, plus my above calculation eliminates any kind of stimulated emission. It is also thought that these isotopes emit neutrinos, but it is not possible that I have discovered a new kind of neutrino detector because calculations (not mine) lead to too small an interaction cross section.

The combination of unquantum effects displayed here, and consistency among effects leave no room for doubt. There is no instrumentation or physical artifact at play to cause this unquantum effect, and I have found it useful in material science investigation. There is no reason to think the unquantum effect is a special case for the three different isotopes I have discovered, and I expect different isotopes and different forms of sources to be discovered. Using my unquantum effect method and the apparatus I will sell employing my method, physicists and educators can test for themselves and find that gamma rays are not photons, and realize how energy is not quantized.

The following claims are to be interpreted in their broadest sense.

1. In a method of measuring energy for studies in physics the steps of:
(a) using a radioisotope source of radiation in spontaneous decay to produce a flux of a characteristic gamma ray, as understood by a characteristic detector pulse amplitude when measured with a detector of a type that delivers substantial pulse amplitude resolution;
(b) implementing a plurality of detectors of said type;
(c) collimating said flux using a suitably dense material of design known in nuclear engineering to narrow said flux into a beam of directed flux;
(d) using each detector of said type to detect a fraction of said flux originating from said beam;
(e) windowing selected amplitude ranges of said characteristic detector pulse amplitude received from each detector of said type to deliver a gate pulse using electronic means known in nuclear engineering;
(f) using a plurality of the gate pulses of step (e) to generate a coincidence gate pulse by means known in nuclear engineering;
(g) using said coincidence gate pulse to calculate an experimental coincidence rate;
(h) subtracting from said experimental coincidence rate a background coincidence rate to calculate a corrected experimental coincidence rate by means known in nuclear engineering;
(i) obtaining a chance coincidence rate expected for said experimental coincidence rate by means well known in nuclear engineering;
(j) taking a ratio of said corrected experimental coincidence rate divided by said chance coincidence rate by a computation means; and
(k) testing for said ratio to exceed unity, whereupon said ratio by exceeding unity refutes the principle of radiant energy quantization, whereby said ratio provides a unique quantitative comparative measure.

2. The method of measuring energy for studies in physics of claim 1 using two detectors of said type in a beam splitter geometry wherein:
(a) step (b) of claim 1 implements two detectors, a channel 1 detector and a channel 2 detector;
(b) a material under study is placed in said beam;
(c) said channel 1 detector is positioned to receive said flux passing directly through said material under study;
(d) said channel 2 detector is positioned to receive said flux that has been deflected at any angle from said material under study;
(e) windowing step (e) of claim 1 receives pulses from channel 1 detector to deliver a channel 1 gate pulse, and receives pulses from channel 2 detector to deliver a channel 2 gate pulse; and
(f) step (f) of claim 1 uses said channel 1 gate pulse and said channel 2 gate pulse to generate a coincidence gate pulse, whereby said coincidence gate pulse is useful for gating data capture of detector events responding to said characteristic gamma ray.

3. The method of measuring energy for studies in physics of claim 2 wherein a process is performed upon said radioisotope source, said process starting with said radioisotope source in the form of a salt solution in water, and said process concluded by electroplating the radioisotope in solution onto a substantially thin conductive metal wire to produce a metallic radioisotope in a compact volume, whereby the gamma rays emitted from said metallic radioisotope provide for a modified value of said ratio useful in investigating properties of gamma rays and said material under study.

4. The method of measuring energy for studies in physics of claim 2 wherein a process is performed upon said radioisotope source of radiation, said process starting with the radioisotope in the form of a salt solution in water, and said process concluded by evaporating the water by a means capable of producing a compact volume of salt in solid form, whereby the gamma rays emitted from said compact volume of salt provide for a modified value of said ratio useful in investigating properties of gamma rays and said material under study.

5. The method of measuring energy for studies in physics of claim 1 using two detectors of said type in a beam splitter geometry wherein:
(a) step (b) of claim 1 implements two detectors, a channel 1 detector and a channel 2 detector;
(b) a material under study is placed in said beam;
(c) said channel 1 detector is positioned to receive said flux passing directly through said material under study;
(d) said channel 2 detector is positioned to receive said flux that has been deflected at any angle from said material under study;
(e) windowing step (e) of claim 1 receives pulses from channel 1 detector to window characteristic gamma ray pulses to deliver a channel 1 gate pulse, and receives pulses from said channel 2 detector to window both the Rayleigh and Compton pulse amplitudes to deliver a channel 2 gate pulse;
(f) said channel 1 detector is positioned to receive said flux passing directly through said material under study;
(g) said channel 2 detector is used to receive said flux that has been deflected at any angle from said material under study;
(h) step (f) of claim 1 uses said channel 1 gate pulse and said channel 2 gate pulse to generate a coincidence gate pulse;
(i) said coincidence gate pulse is used to gate analog pulses originating from said channel 2 detector to create a coincidence-gated pulse amplitude histogram;
(j) said coincidence-gated pulse amplitude histogram is sectioned into a Rayleigh section and a Compton section according to known meaning in nuclear physics;
(k) a rate in said Rayleigh section is calculated to obtain a Rayleigh rate, and a rate in said Compton section is calculated to obtain a Compton rate; and
(l) a ratio of said Rayleigh rate divided by said Compton rate is calculated for use in comparative measurements.

6. The method of measuring energy for studies in physics of claim 5 wherein a process is performed upon said radioisotope source, said process starting with said radioisotope source in the form of a salt solution in water, and said process concluded by electroplating the radioisotope in solution onto a substantially thin conductive metal wire to produce a metallic radioisotope in a compact volume, whereby the gamma rays emitted from said metallic radioisotope provide for a modified value of said ratio useful in investigating properties of gamma rays and said material under study.

7. The method of measuring energy for studies in physics of claim 5 wherein a process is performed upon said radioisotope source of radiation, said process starting with the radioisotope in the form of a salt solution in water, and said process concluded by evaporating the water by a means capable of producing a compact volume of salt in solid form, whereby the gamma rays emitted from said compact volume of salt provide for a modified value of said ratio useful in investigating properties of gamma rays and said material under study.

8. The method of measuring energy for studies in physics of claim 1 using two detectors of said type in a tandem geometry wherein:
(a) step (b) of claim 1 implements two detectors, a channel 1 detector and a channel 2 detector;
(b) said channel 1 detector is positioned to receive said flux and designed as a sufficiently thin detector to allow a significant fraction of said flux to pass directly through;
(c) said channel 2 detector is positioned to receive said flux passing through said channel 2 detector and designed as a sufficiently thick detector to absorb the majority of incident flux; and
(d) windowing step (e) of claim 1 receives pulses from channel 1 detector to deliver a channel 1 gate pulse, and receives pulses from channel 2 detector to deliver a channel 2 gate pulse;
(e) step (f) of claim 1 uses said channel 1 gate pulse and said channel 2 gate pulse to generate a coincidence gate pulse, whereby said coincidence gate pulse is useful for gating data capture of detector events responding to said characteristic gamma ray.

9. The method of measuring energy for studies in physics of claim 8 wherein a material under study is said radioisotope source of radiation and an adjustment in crystalline state and mixture with other materials is performed upon said radioisotope, whereby classical gamma ray properties are quantitatively investigated.

10. An apparatus for studies in physics and material science comprising:
(a) a source selected from the group consisting of cadmium-109 and cobalt-57 emitting a flux of a characteristic gamma ray;
(b) a collimating means surrounding said source to narrow said flux to a beam of radiation;
(c) a material under study placed in said beam, said material of thickness that provides transmission of a non-trivial fraction of said beam;
(d) a channel 1 detector to intercept most of said beam, deliver an electrical pulse of amplitude characteristic of said flux, and have substantial pulse amplitude resolution, by means well known in nuclear engineering;
(e) a means of mounting and articulating an angle said material receives said beam;
(f) a channel 2 detector to avoid intercepting radiation within a solid angle of said beam, intercept a reasonably detectable portion of radiation scattered from said material, deliver an electrical pulse of amplitude characteristic of said flux, and have substantial pulse amplitude resolution, by means well known in nuclear engineering;
(g) circuitry standard in nuclear engineering for amplifying, shape-amplifying, and windowing signals from said channel 1 detector with window of channel 1 accepting pulse amplitudes characteristic of said flux to create a channel 1 gate pulse and a channel 1 shaped pulse,
(h) circuitry standard in nuclear engineering for amplifying, shape-amplifying, and windowing signals from said channel 2 detector with window of channel 2 set to include Rayleigh and Compton pulse amplitudes characteristic of said flux to create a channel 2 gate pulse and a channel 2 shaped pulse;
(i) coincidence circuitry standard in nuclear engineering to receive said channel 1 gate pulse and said channel 2 gate pulse to output a coincidence gate pulse;
(j) a means well known in nuclear engineering of counting the coincidence gate pulses, a time duration of this counting, and a background rate to calculate a coincidence rate;
(k) a means well known in nuclear engineering of obtaining a chance coincidence rate expected for said coincidence rate;
(l) a means of taking a ratio of said coincidence rate divided by said chance coincidence rate; and
(m) a means of testing for said ratio to exceed unity, whereupon said ratio by exceeding unity refutes the principle of radiant energy quantization, whereby said ratio provides a unique quantitative comparative measure and said coincidence gate pulse is useful for gating data capture of detector events responding to said characteristic gamma ray.

11. The apparatus for studies in physics and material science of claim 10 further including:
(a) a means of using said coincidence gate pulse to gate capture of the channel 2 shaped pulses to create a histogram of coincidence-gated pulse amplitudes;
(b) a means of sectioning said histogram into a Rayleigh section and a Compton section according to known physical meaning;
(c) a means of calculating rates in said Rayleigh section and said Compton section to create a Rayleigh rate and a Compton rate; and
(d) a means of calculating said Rayleigh rate divided by said Compton rate to obtain a R/C ratio, whereby said R/C ratio is a useful comparative measure.

12. In a method of measuring gamma rays the steps of:
(a) using a source of radiation selected from the group consisting of cadmium-109 and cobalt-57 to produce a flux of a characteristic gamma ray, as understood by a characteristic detector pulse amplitude when measured with a detector of a type that delivers substantial pulse amplitude resolution;
(b) implementing a single detector of said type;
(c) using said single detector to intercept a substantial fraction of said flux;
(d) converting pulses from said single detector to a histogram of pulse amplitudes by means standard in nuclear engineering;
(e) windowing a sum-peak section on said histogram at the pulse amplitude of twice said characteristic detector pulse amplitude to generate a measured sum-peak rate by means known in nuclear engineering;
(f) correcting said measured sum-peak rate for background by known nuclear engineering means to create a corrected measured sum-peak rate.
(e) generating a chance sum-peak rate of pulses expected in said sum-peak section by means known in nuclear engineering;
(f) calculating a ratio of said corrected measured sum-peak rate divided by said chance sum-peak rate by means known in nuclear engineering; and
(g) testing for said ratio to exceed unity, whereupon said ratio by exceeding unity refutes the principle of radiant energy quantization, whereby said ratio provides a unique quantitative comparative measure.

13. The method of measuring gamma rays of claim 12 wherein:
(a) a material under study is said source; and
(b) a chemical adjustment is performed upon said source.

14. A method of measuring energy in violation of the principle of the photon in a two-part beam split test:
(a) using a source of radiation selected from the group consisting of cadmium-109 and cobalt-57 emitting a characteristic gamma ray;
(b) detecting said characteristic gamma ray using detectors of a type with substantial pulse amplitude resolution and high photoelectric effect efficiency for said characteristic gamma ray to produce a detection event;
(c) measuring a plurality of the detection events in coincidence to produce a coincidence pulse by a means well known in nuclear engineering;
(d) calculating a chance coincidence rate that is predicted for said coincidence rate by a means well known in nuclear engineering;
(e) calculating a ratio of said coincidence rate divided by said chance coincidence rate; and
(f) testing for said ratio to exceed unity, whereupon said ratio by exceeding unity refutes the principle of radiant energy quantization, whereby said ratio provides a unique quantitative comparative measure.

15. A method of measuring energy in violation of the principle of energy quantization in a two-part beam split test:
(a) using a radioisotope in spontaneous decay emitting a characteristic energy;
(b) detecting said characteristic energy using detectors of a type with substantial pulse amplitude resolution and high efficiency for said characteristic energy to produce a characteristic detection event;
(c) measuring a plurality of the characteristic detection events in coincidence to produce a coincidence pulse by a means well known in nuclear engineering;
(d) calculating a coincidence rate from said coincidence pulse;
(e) calculating a chance coincidence rate that is predicted for said coincidence rate by a means well known in nuclear engineering;
(f) calculating a ratio of said coincidence rate divided by said chance coincidence rate; and
(g) testing said ratio to exceed unity, whereupon by exceeding unity said ratio refutes the principle of energy quantization, whereby said ratio is a unique quantitative comparative measure and said coincidence pulse is a unique gate pulse useful for gating data capture of detector events responding to said characteristic energy.

16. The method of measuring energy of claim 15 wherein said characteristic energy is a gamma ray.

17. The method of measuring energy of claim 16 wherein said characteristic energy is a 88 kiloelectron-volt gamma ray from cadmium-109.

18. The method of measuring energy of claim 16 wherein said characteristic energy is a 122 kiloelectron-volt gamma ray from cobalt-57.

19. The method of measuring energy of claim 16 wherein said characteristic energy is a 662 kiloelectron-volt gamma ray from cesium-137.
